(19) United States
(12) Patent Application Publication
(10) Pub. No.: US 2004/0210652 A1
(43) Pub. Date: Oct. 21, 2004

(54) Data transmission apparatus, data reception apparatus, data communication system, and data communication administration server

(76) Inventors: Kazuya Oyama, Ikoma-Shi (JP); Sadahiko Hinoue, Nara-Shi (JP); Toru Ueda, Soraku-Gun (JP)

Correspondence Address: BIRCH STEWART KOLASCH & BIRCH, PO BOX 747, FALLS CHURCH, VA, 22040-0747, US

(21) Appl. No.: 10/814,119

(22) Filed: Apr. 1, 2004

(30) Foreign Application Priority Data
Apr. 3, 2003 (JP) 2003-100679

(51) Int. Cl. G06F 15/173; G06F 17/30; H04L 12/28; G06F 7/00; H04L 12/56

(52) U.S. Cl. 709/223; 707/10

(57) ABSTRACT

To achieve communication, an AV data reception apparatus transmits an ID with which it permits itself to be identified to an AV data transmission apparatus. On receiving this ID, the AV data transmission apparatus identifies, based on the ID, the functions compatible with the AV data reception apparatus, and changes the functions of its own communication operation blocks according to those identified functions.

This nonprovisional application claims priority under 35 U.S.C. § 119(a) on Patent Application No. 2003-100679 filed in Japan on Apr. 3, 2004, the entire contents of which are hereby incorporated by reference.

### BACKGROUND OF THE INVENTION

1. Field of the Invention

The present invention relates to a data transmission apparatus, a data reception apparatus, and a data communication system, all for performing data communication. More particularly, the present invention relates to a data transmission apparatus, a data reception apparatus, and a data communication system that perform data communication by using a data communication function common among parties engaged in the data communication.

2. Description of the Prior Art

In recent years, the complexity of wired connection and the development of wireless technology have prompted the emergence of AV data wireless communication systems in which AV data is transmitted from an AV source apparatus, such as a tuner, a video player, or a DVD player, to an AV reproduction apparatus, such as a display or projector, so that video and audio are reproduced as images and sounds on the AV reproduction apparatus (see Japanese Patent Applications Laid-Open Nos. H9-74498 and 2000-251456). The configuration of an AV data transmission apparatus and an AV data reception apparatus used in such an AV data wireless communication system is shown in FIGS. 28 and 29, respectively.

The AV data transmission apparatus 100 shown in FIG. 28 is provided with: a CPU 101 that controls the apparatus as a whole; a system control section 102 that exchanges data between, at one end, the CPU 101 and a main memory 104 and, at the other, other blocks of the apparatus; a BIOS section 103 that stores various settings and programs relating to the most basic operations of the apparatus and that operates according to those settings and programs at start-up; a main memory 104 that is administered by the CPU 101 and that stores programs, data, and the like; a display control section 105 that controls the display operation of a display section 107; a video memory 105a that holds video data corresponding to one frame to be displayed on the display section 107; a recording device section 106 composed of a hard disk, high-capacity nonvolatile memory, or the like that stores a large amount of programs and data; a display section 107 composed of an LCD (liquid crystal display) or the like; an input control section 108 that recognizes data inputted via an input section 109; and an input section 109 composed of members operated by the user, such as a power switch, a keyboard, a mouse, and a remote control unit.

Moreover, to realize the transmission-related functions thereof, the AV data transmission apparatus 100 is also provided with: a video AD conversion section 110 that converts an analog video signals into a digital signal; a video encoding section 111 that performs data conversion on the thus digitized video signal in a way that suits the reception function of an AV data reception apparatus 200; an audio AD conversion section 112 that converts an analog audio signal into a digital signal; an audio encoding section 113 that performs data conversion on the thus digitized audio signal in a way that suits the reception function of the AV data reception apparatus 200; a data generation section 114 that converts the thus converted video and audio signals into packets that suit the communication method used; an error correction coding section 115 that adds error correction codes to those packets; and an encryption section 116 that encrypts, according to an encryption code stored in the main memory 104, the data packets that thus have the error correction codes added thereto.

Moreover, to realize the reception-related functions thereof, the AV data transmission apparatus 100 is also provided with: a decryption section 117 that decrypts, according to the encryption code stored in the main memory 104, data packets received and fed from a BB section 120; a data reception section 118 that analyzes and rearranges the thus decrypted data packets and that, when resending needs to be requested, instructs a resending request confirmation section 119 to request resending; and a resending request confirmation section 119 that, according to the request for resending from the data reception section 118, generates data of which the resending is requested and that then instructs the data generation section 114 to transmit a packet of which the resending is requested.

Furthermore, the AV data transmission apparatus 100 is also provided with: a BB section 120 that converts the encrypted data packets into a baseband signal by a procedure that suits the communication method and that also converts a received baseband signal into data packets that can be handled by the apparatus; an RF section 121 that modulates the baseband signal into a high-frequency signal and that also demodulates a high-frequency signal into a base-band signal; an antenna 122 that performs wireless communication; and a bus line 123 by way of which data is exchanged between, at one end, the system control section 102 and, at the other, the video AD conversion section 110, video encoding section 111, data generation section 114, encryption section 116, decryption section 117, and data reception section 118. Moreover, the audio AD conversion section 112 exchanges data with the system control section 102 by way of the video AD conversion section 110 and the bus line 123, and the audio encoding section 113 exchanges data with the system control section 102 by way of the video encoding section 111 and the bus line 123.

The AV data transmission apparatus 100 configured as described above is further provided with: a TV tuner video section 130 that decodes video and audio signals from input signals such as those fed from a television antenna or those fed to a video input terminal, to a D terminal, or to LR audio terminals; and a recording device playback section 131 that decodes video and audio signals by reproducing AV data recorded on a recording medium such as a CD, DVD, memory card, or magneto-optical disk. The TV tuner video section 130 and the recording device playback section 131 may be built as a separate apparatus that is externally connected to the AV data transmission apparatus 100.

The AV data reception apparatus 200 shown in FIG. 29 is provided with: a CPU 201, a system control section 202, a BIOS section 203, a main memory 204, a display control section 205, a video memory 205a, a display section 207, an input control section 208, an input section 209, a data generation section 216, an error correction coding section 217, an encryption section 218, a decryption section 213, a data reception section 214, a resending requesting section 215, a BB section 212, an RF section 211, and an antenna 210, which function in similar manners to the blocks 101 to 105, 105a, 107 to 109, 114 to 118, and 120 to 122, respectively, of the AV data transmission apparatus 100.

Here, the display section 207 is composed of an LCD or CRT (cathode ray tube). The data reception section 214 separates video and audio signals from data packets, and feeds them to a video decoding section 219 and an audio decoding section 220. The data generation section 216 converts various kinds of information (such as acknowledgment (ACK) signals and resending request commands to be included in communication packets) for receiving AV data and commands from the remote control unit into packets that suit the communication method used.

Furthermore, the AV data reception apparatus 200 is also provided with: a resending requesting section 215 that, based on the condition of the data packets fed to the data reception section 214, identifies the data packet of which resending is to be requested from the AV data transmission apparatus 100, that then generates data for requesting resending, and that then feeds it to the data generation section 216; a video decoding section 219 that performs data conversion on the video signal obtained from the data reception section 214 so as to convert it into video that can be displayed on the display section 207; an audio decoding section 220 that performs data conversion on the audio signal obtained from the data reception section 214 so as to convert it into audio that can be outputted from an audio output section 221; and an audio output section 221, such as a loud speaker, that reproduces the data from the audio decoding section 220 into sounds audible to humans.

With the AV data transmission apparatus 100 and the AV data reception apparatus 200 configured as described above, in the AV data transmission apparatus 100, analog video and audio signals obtained from the TV tuner video section 130 or the recording device playback section 131 are converted into digital signals by the video AD conversion section 110 and the audio AD conversion section 112, and are then fed through the video encoding section 111 and the audio encoding section 113 to the data generation section 114 to generate data packets. Incidentally, in a case where the video and audio signals obtained form the TV tuner video section 130 or the recording device playback section 131 are digital, they are fed to the video encoding section 111 and the audio encoding section 113 without being converted into digital signals by the video AD conversion section 110 and the audio AD conversion section 112.

The data generation section 114 recognizes those data packets of which resending is requested as confirmed by the resending request confirmation section 119, and feeds the error correction coding section 115 with those data packets, of which resending is requested, along with the data packets generated from the video and audio signals from the video encoding section 111 and the audio AD conversion section 112. The error correction coding section 115 adds error correction codes to the data packets, which are then fed to the encryption section 116, to which an encryption code in the main memory 104 is fed through the system control section 102 and the bus line 123, so as to be encrypted with that encryption code. Thereafter, the encrypted data packets are converted by the BB section 120 into a baseband signal, which is then modulated into a high-frequency signal by the RF section 121 and is then transmitted from the antenna 122.

When this high-frequency signal transmitted form the AV data transmission apparatus 100 is received by the AV data reception apparatus 200 with the antenna 210 thereof, then, in the RF section 211, it is demodulated into a baseband signal, which is then converted by the BB section 212 into data packets. These data packets from the BB section 212 are then fed to the decryption section 213, to which an encryption code in the main memory 204 is fed through the system control section 202 and the bus line 222, so as to be decrypted with that encryption code. The data packets are then, in the data reception section 214, subjected to error correction using error correction codes fed from the error correction coding section 217, and are then split into video and audio signals, which are then decoded by the video decoding section 219 and the audio decoding section 220, respectively.

The video signal is then subjected to data conversion in the video decoding section 219, and is then fed through the bus line 222 and the system control section 202 to the display control section 205, which then stores the video data resulting from the data conversion, one frame at a time, in the video memory 205a. When the time comes at which to reproduce the video data in the video memory 205a, it is read out by the display control section 205, and the image reproduced therefrom is displayed on the display section 207. On the other hand, the audio data resulting from data conversion in the audio decoding section 220 is fed to the audio output section 221 so as to be reproduced as sounds.

When control data for controlling the operation of the AV data transmission apparatus 100 is fed in through the input section 209, it is fed through the input control section 208, the system control section 202, and the bus line 222 to the data generation section 216. Moreover, the resending requesting section 215 is notified of which among the data packets received by the data reception section 214 to request resending of, and thus, based on the resending request data in the resending requesting section 215, the data generation section 216 generates ACK signals, indicating successful reception, and resending request commands. Then, the data generation section 216 converts the ACK signals and resending request commands along with control data and the like into packet data.

The error correction coding section 217 adds error correction codes to the data packets outputted from the data generation section 216, and the data packets are then fed to the encryption section 218, to which an encryption code in the main memory 204 is fed through the system control section 202 and the bus line 222, so as to be encrypted with that encryption code. The data packets are then converted by the BB section 212 into a baseband signal, which is then modulated into a high-frequency signal by the RF section 211 and is then transmitted from the an antenna 210 to the AV data transmission apparatus 100.

When this high-frequency signal is received by the AV data transmission apparatus 100 with the antenna 122 thereof, it is demodulated into a baseband signal by the RF section 121, and is then converted into data packets by the BB section 120. These data packets are then fed to the decryption section 117, to which an encryption code in the main memory 104 is fed through the system control section 102 and the bus line 123, so as to be decrypted with that encryption code. The data packets are then, in the data reception section 118, subjected to error correction using error correction codes from the error correction coding section 115.

Then, if an obtained packet contains an ACK signal, the data reception section 118 notifies the resending request confirmation section 119 of successful reception; if an obtained packet contains a resending request command, the data reception section 118 feeds the resending request data to the resending request confirmation section 119; if an obtained packet contains control data, the data reception section 118 feeds it to the system control section 102 through the bus line 123. As a result, when the resending request confirmation section 119 receives resending request data, based on the resending request data, the resending request confirmation section 119 identifies which data packet to request resending of and notifies the data generation section 114 of it. On the other hand, when the system control section 102 receives control data, it instructs the relevant blocks to perform control operations according to the control data.

In the AV data transmission apparatus 100 and the AV data reception apparatus 200 operating as described above, their control operations and functions are fixed. That is, their BIOS sections 103 and 203 and the like are so preprogrammed that the two apparatuses work together, and generally cannot be changed afterwards. Even when their control operations and functions can ever be changed afterwards, their BIOS sections 103 and 203 need to be changed simultaneously so that the two apparatuses work together. Thus, wireless transmission of AV data is possible only between an AV data transmission apparatus 100 and an AV data reception apparatus 200 of which the combination is presupposed.

Thus, according to the prior-art technology as disclosed in Japanese Patent Applications Laid-Open Nos. H9-74498 and 2000-251456 mentioned earlier, it is essential that the functions of an AV data transmission apparatus and of an AV data reception apparatus be mutually adapted. As a result, wireless AV data transmission is possible only between such apparatuses as are compatibly configured at the time of shipment. That is, when a new model of an AV data transmission apparatus or an AV data reception apparatus is introduced, its partner, i.e., an AV data reception apparatus or an AV data transmission apparatus respectively, also needs to be replaced with a new model.

### SUMMARY OF THE INVENTION

An object of the present invention is to provide a data transmission apparatus that can identify the function used by a data reception apparatus in order to adapt the communication function of the data transmission apparatus itself to one compatible with the data reception apparatus. Another object of the present invention is to provide a data reception apparatus that transmits a signal that permits such a data transmission apparatus to identify the function of the data reception apparatus itself. Still another object of the present invention is to provide a data communication system built with such a data transmission apparatus and such a data reception apparatus. A further object of the present invention is to provide a data communication administration server that administers data used to identify particular data communication functions in such a data communication system.

To achieve the above objects, according to one aspect of the present invention, a data transmission apparatus is provided with: a data generator that generates data transmitted to a data reception apparatus; a data analyzer that analyzes data received from the data reception apparatus; a transmitter/receiver that transmits and receives data to and from the data reception apparatus; and an individual compatibility information storage in which is stored a first function identification table with reference to which data communication functions used to perform data communication with the data reception apparatus are identified respectively for individual items of specific data with which the data reception apparatus permits itself to be identified. Here, when the specific data is fed through the data transmitter/receiver to the data analyzer, with reference to the first function identification table in the individual compatibility information storage, the data communication functions recognized from the specific data are identified and are brought into effect so that the data transmission apparatus is brought into a state communicable with the data reception apparatus that has transmitted the specific data thereto.

According to another aspect of the present invention, a data transmission apparatus is provided with: a data generator that generates data transmitted to a data reception apparatus; a data analyzer that analyzes data received from the data reception apparatus; a transmitter/receiver that transmits and receives data to and from the data reception apparatus; and an individual compatibility information storage in which is stored a first function identification table in which are recorded data communication functions corresponding respectively to individual codes contained in function data with which the reception apparatus permits data communication functions used for communication therewith to be identified. Here, when the function data is fed through the data transmitter/receiver to the data analyzer, with reference to the first function identification table in the individual compatibility information storage, the data communication functions recognized from the codes contained in the function data are identified and are brought into effect so that the data transmission apparatus is brought into a state communicable with the data reception apparatus that has transmitted the function data thereto.

According to another aspect of the present invention, a data reception apparatus is provided with: a data analyzer that analyzes data received from a data transmission apparatus; a data generator that generates data transmitted to the data transmission apparatus; a transmitter/receiver that transmits and receives data to and from the data transmitting apparatus; and a specific data storage in which is stored specific data with which the data reception apparatus permits itself to be identified. Here, the specific data read out from the specific data storage is transmitted from the transmitter/receiver to the data transmission apparatus so that a data communication function compatible with the data receiving apparatus is identified and brought into effect in the data transmission apparatus so that the data transmission apparatus is brought into a state communicable with the data reception apparatus.

According to another aspect of the present invention, a data reception apparatus is provided with: a data analyzer that analyzes data received from a data transmission apparatus; a data generator that generates data transmitted to the data transmission apparatus; a transmitter/receiver that transmits and receives data to and from the data transmitting apparatus; and a specific data storage in which is stored function data composed of codes with which the data reception apparatus permits a data communication function that needs to be used in communication therewith to be identified. Here, the function data read out from the specific data storage is transmitted from the transmitter/receiver to the data transmission apparatus so that the data communication function compatible with the data receiving apparatus is identified and brought into effect in the data transmission apparatus so that the data transmission apparatus is brought into a state communicable with the data reception apparatus.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing the configuration of a data communication system according to the invention;

FIG. 2 is a block diagram showing the internal configuration of a data transmission apparatus according to the invention;

FIG. 3 is a block diagram showing the internal configuration of a data reception apparatus according to the invention;

FIG. 4 is a block diagram showing the internal configuration of a data communication administration server according to the invention;

FIG. 5 is a diagram showing an example of the configuration the function identification table stored in the data transmission apparatus in the first embodiment;

FIG. 6 is a block diagram showing the internal configuration of the video encoding section provided in the data transmission apparatus shown in FIG. 2;

FIG. 7 is a block diagram showing the internal configuration of the audio encoding section provided in the data transmission apparatus shown in FIG. 2;

FIG. 8 is a flow chart showing the initial setting operation of the data transmission apparatus in the first embodiment;

FIG. 9 is a flow chart showing the function changing operation of the data transmission apparatus;

FIG. 10 is a flow chart showing the shut-down operation of the data transmission apparatus;

FIG. 11 is a diagram showing an example of the configuration of the model identification table stored in the data communication administration server in the second embodiment;

FIG. 12 is a diagram showing an example of the configuration of the function identification table stored in the data communication administration server in the second embodiment;

FIG. 13 is a diagram showing an example of the configuration of the function identification table stored in the data transmission apparatus in the second embodiment;

FIG. 14 is a flow chart of the operation of the data communication administration server when function data is requested in the second embodiment;

FIG. 15 is a diagram showing an example of the configuration of the apparatus ID in the third embodiment;

FIG. 16 is a diagram showing an example of the configuration of the function identification table stored in the data transmission apparatus in the third embodiment;

FIG. 17 is a diagram showing an example of the configuration of the function identification table stored in the data communication administration server in the third embodiment;

FIG. 18 is a diagram showing an example of the configuration of the permitted apparatus table stored in the data communication administration server in the third embodiment;

FIG. 19 is a flow chart of the initial setting operation of the data transmission apparatus in the third embodiment;

FIG. 20 is a flow chart of the operation of the data communication administration server when function data is requested in the third embodiment;

FIG. 21 is a diagram showing an example of the configuration of the function addition data;

FIG. 22 is a diagram showing an example of the display that permits selection among various functional conditions in the data reception apparatus in the fourth embodiment;

FIG. 23 is a block diagram showing the operation of the data communication system in the fourth embodiment;

FIG. 24 is a diagram showing an example of the display that permits the setting of the operation mode in which to perform the function changing operation in the fifth embodiment;

FIG. 25 is a flow chart showing the operation for selecting among the different operation modes set for the function changing operation in the fifth embodiment;

FIG. 26 is a diagram showing an example of the configuration of the function data in the sixth embodiment;

FIG. 27 is a diagram showing an example of the display that permits the choice of whether to perform downloading automatically or not;

FIG. 28 is a block diagram showing the internal configuration of a conventional data transmission apparatus; and

FIG. 29 is a block diagram showing the internal configuration of a conventional data reception apparatus.

### DESCRIPTION OF THE PREFERRED EMBODIMENTS

First Embodiment

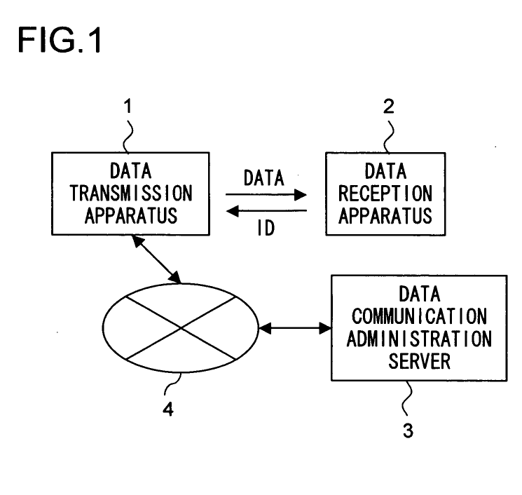

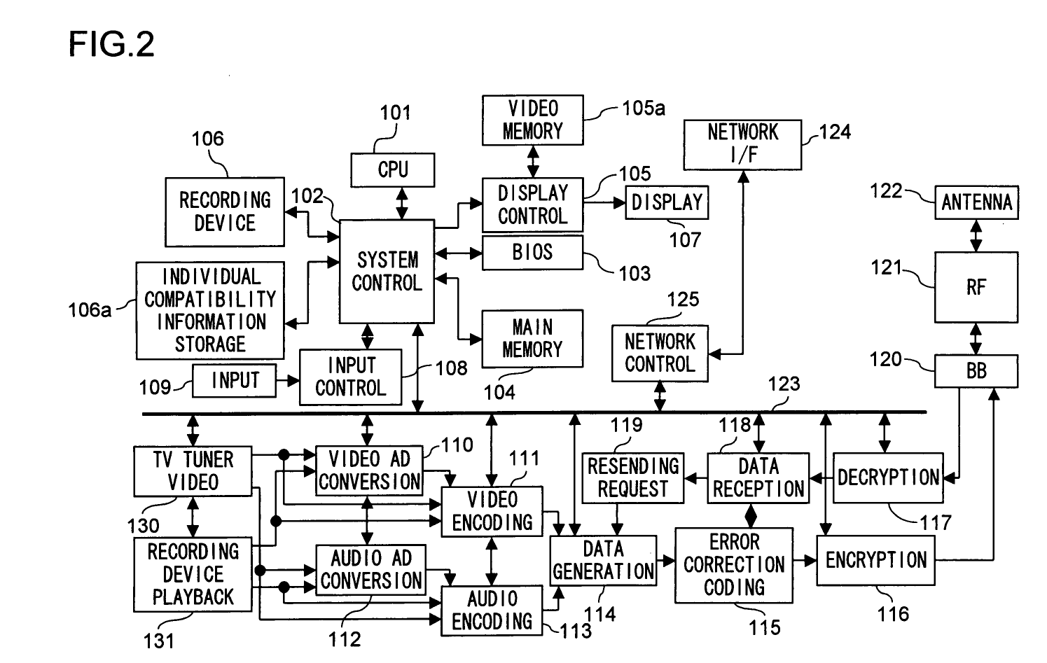

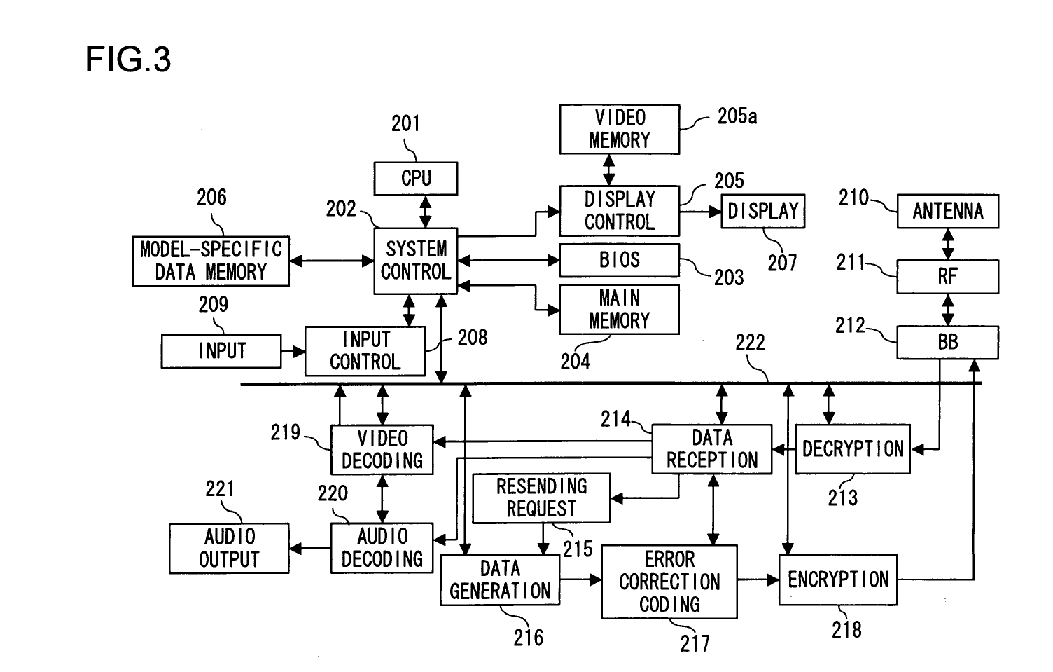

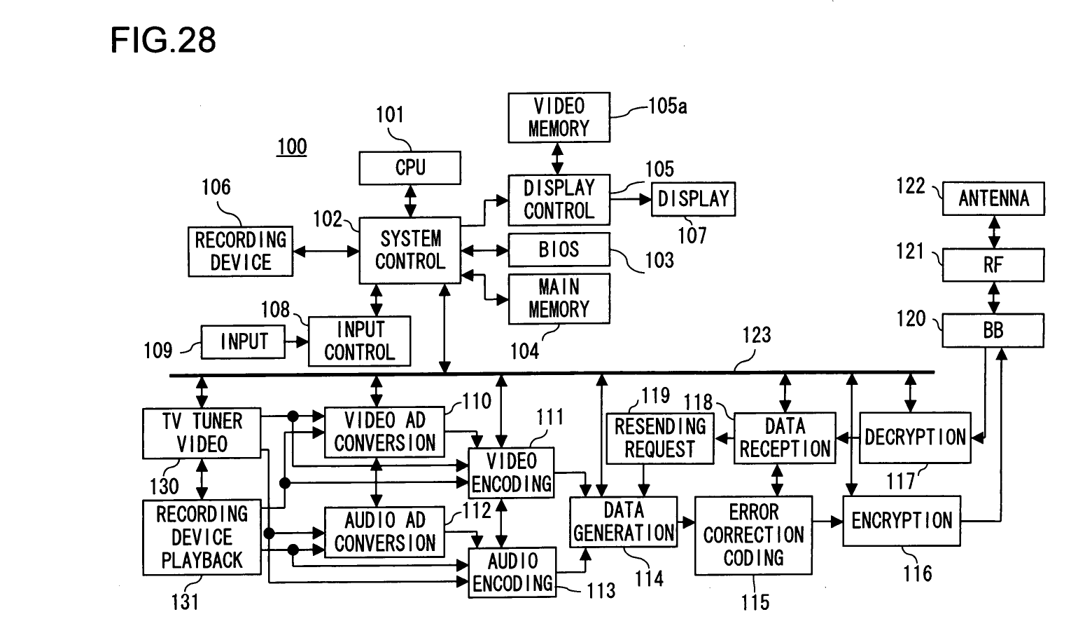

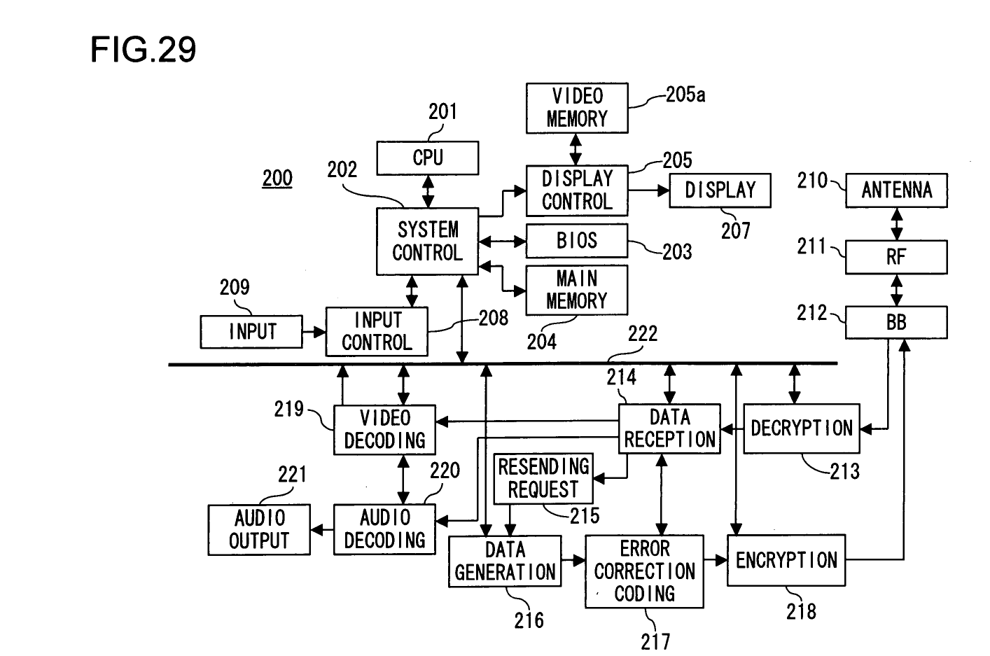

A first embodiment of the present invention will be described below with reference to the drawings. FIG. 1 is a block diagram showing the configuration of the AV data wireless communication system of this embodiment. FIG. 2 is a block diagram showing the internal configuration of the AV data transmission apparatus used in this embodiment, and FIG. 3 is a block diagram showing the internal configuration of the AV data reception apparatus used in this embodiment. It should be noted that, in FIGS. 2 and 3, such blocks as are found also in FIGS. 28 and 29 are identified with the same reference numerals, and their detailed explanations will not be repeated.

The AV data wireless communication system shown in FIG. 1 is provided with: an AV data transmission apparatus 1 that transmits AV data; an AV data reception apparatus 2 that receives the AV data transmitted from the AV data transmission apparatus 1; an AV data communication administration server 3 that is provided with a database relating to the AV data transmission apparatus 1 and the AV data reception apparatus 2 and that performs communication with the AV data transmission apparatus 1 over a network 4; and a network 4 that permits communication by way of a telephone network, DSL network, wireless network, optical fiber network, or the like.

In this AV data wireless communication system, as shown in FIG. 2, the AV data transmission apparatus 1 is provided with, in addition to the configuration of the AV data transmission apparatus 100 shown in FIG. 28: an individual compatibility information storage section 106a; a network interface 124, such as a modem or network card, that achieves connection with the network 4; and a network control section 125 that controls the connection with the network handled by the network interface 124. On the other hand, as shown in FIG. 3, the AV data reception apparatus 2 is provided with, in addition to the configuration of the AV data reception apparatus 200 shown in FIG. 29, a specific data memory 206 that stores model-specific data that permits the AV data transmission apparatus 1 to identify the model of the AV data reception apparatus 2 itself.

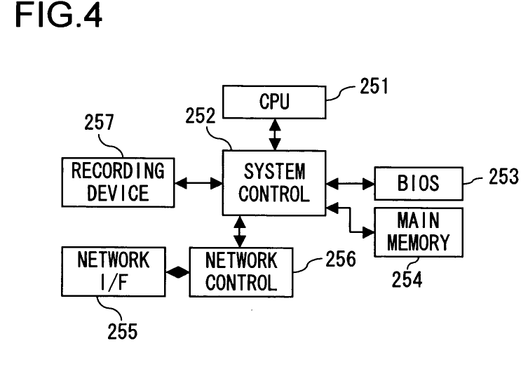

As shown in FIG. 4, the AV data communication administration server 3 is provided with: a CPU 251 that controls the server as a whole; a system control section 252 that exchanges data between, at one end, the CPU 251 and a main memory 254 and, on the other, other blocks of the server; a BIOS section 253 that stores settings and programs relating to the most basic operations of the server and that operates according to those settings and programs at start-up; a main memory 254 that is administered by the CPU 251 and that stores programs, data, and the like; a network interface 255, such as a modem or network card, that achieves connection with the network 4; a network control section 256 that controls the connection with the network handled by the network interface 255; and a recording device section 257 that stores a data table relating to the functions of the AV data reception apparatus 2 and software programs that achieve those functions.

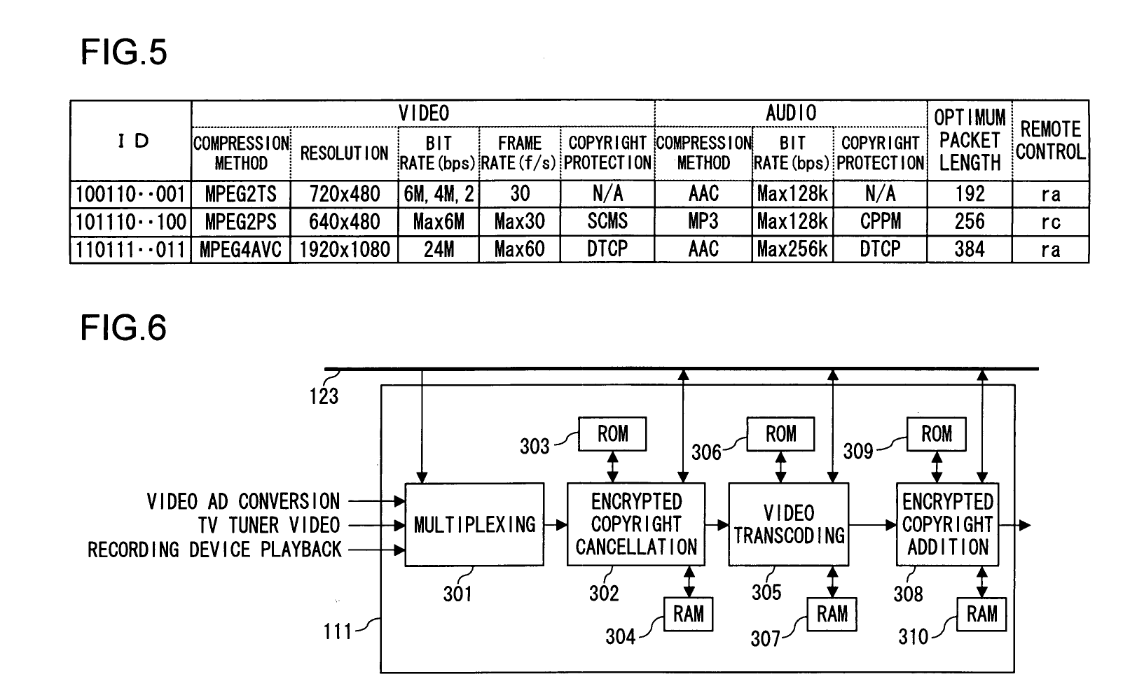

The individual apparatuses provided in the AV data wireless communication system shown in FIG. 1 are configured as described above. Here, in the AV data transmission apparatus 1, the individual compatibility information storage section 106a incorporates a data table with reference to which the functions of a plurality of types of AV data reception apparatus 2 are identified (hereinafter, this data table will be referred to as the “function identification table”). As shown in FIG. 5, this function identification table contains, as function data, the functions of different models of the AV data reception apparatus 2 in association with their respective model IDs. For example, for each model ID, there are stored, as function data, the following parameters, which are used in that model of the AV data reception apparatus 2: with respect to the video signal, the compression method, the bit rate, the encrypted copyright method for copyright protection, and the resolution and the frame rate at playback; with respect to the audio signal, the compression method, the bit rate, and the encrypted copyright method for copyright protection; and also the optimum packet length, the remote control method used, etc.

As shown in FIG. 6, the video encoding section 111 provided in the AV data transmission apparatus 1 is provided with: a multiplexing section 301 that selects one from among the video signals fed in as digital signals from a plurality of sources; an encrypted copyright cancellation section 302 that cancels the encrypted copyright signal added to the video signal fed to the multiplexing section 301; a video transcoding section 305 that converts the video signal from the copyright protection decryption section 302 into a format compatible with the AV data reception apparatus 2; and an encrypted copyright addition section 308 that adds an encrypted copyright signal to the video signal from the video transcoding section 305.

This video encoding section 111 is further provided with: ROMs 303, 306, and 309 in which is stored firmware for controlling the operation of the encrypted copyright cancellation section 302, video transcoding section 305, and encrypted copyright addition section 308, respectively; and RAMs 304, 307, and 310 that are used as work or cache memory during the operation of the encrypted copyright cancellation section 302, video transcoding section 305, and encrypted copyright addition section 308, respectively.

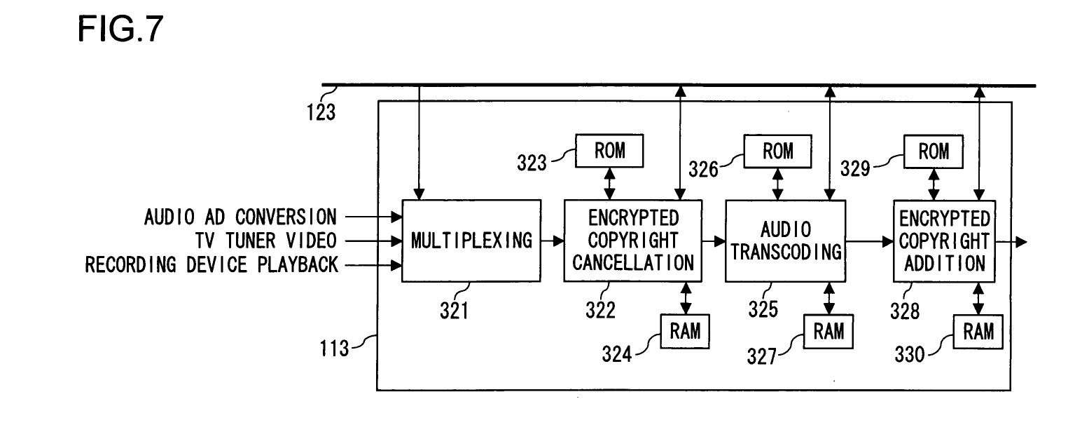

The audio encoding section 113 is configured, with respect to audio signals fed in as digital signals, in a similar manner to the video encoding section 111. Specifically, as shown in FIG. 7, the audio encoding section 113 is provided with: a multiplexing section 321, an encrypted copyright cancellation section 322, an audio transcoding section 325, an encrypted copyright addition section 328, ROMs 323, 326, and 329, and RAMs 324, 327, and 330, which function in similar manners to the multiplexing section 301, encrypted copyright cancellation section 302, video transcoding section 305, encrypted copyright addition section 308, ROMs 303, 306, and 309, and RAMs 304, 307, and 310, respectively, provided in the video encoding section 111.

The encrypted copyright cancellation sections 302 and 322, video transcoding section 305, audio transcoding section 325, and encrypted copyright addition sections 308 and 328 each exchange commands and data with the system control section 102 through the bus line 123, and are so configured that their DSP (digital signal processing) functions are provided either in the form of firmware so as to be updatable or in the form of hardware in such a way as to be selectable from among a plurality of functions.

When the video and audio signals that are fed in comply with the encrypted copyright method used in the AV data reception apparatus 2, the encrypted copyright cancellation sections 302 and 322 and the encrypted copyright addition sections 308 and 328 perform neither encryption cancellation nor encryption addition on those signals, and feed them intact to the following-stage circuits. When the video and audio signals that are fed in are encoded in a format that can be handled by the AV data reception apparatus 2, the video transcoding section 305 and the audio transcoding section 325 perform no conversion processing on those signals, and feed them intact to the following-stage circuits. The ROMs 303, 306, 309, 323, 326, and 329 are so configured that their functions are provided in the form of firmware incorporated therein so as to be updatable, and are thus so configured as to include nonvolatile memory.

The recording device section 106 may be so configured that it can record the video and audio signals fed as digital signals from the TV tuner video section 130, recording device playback section 131, video AD conversion section 110, or audio AD conversion section 112. In that case, the video and audio signals from the recording device section 106 are fed to the multiplexing sections 301 and 321 of the video encoding section 111 and the audio encoding section 113.

In the AV data transmission apparatus 1 configured as described above, when the input section 109 is so operated as to start up, an instruction to start up is fed through the input control section 108 to the system control section 102. This makes the CPU 101 to read out the programs in the BIOS section 103 through the system control section 102. The CPU 101 then makes initial settings on the individual blocks in the apparatus through the system control section 102.

Alternatively, when a high-frequency signal containing control data requesting start-up is received via the antenna 122, a data packet is fed through the RF section 121, BB section 120, and decryption section 117 to the data reception section 118, and, from this data packet, the control data is recognized. This control data is fed through the bus line 123 to the system control section 102, which is thereby notified that an instruction to start up is received. This makes the CPU 101 to perform the same operation as it does when the input section 109 is operated, so that initial settings are made on the individual blocks in the apparatus. To achieve this, the AV data transmission apparatus 1, even in a shut-down state, keeps supplying power to those blocks which need to be always operating, such as the system control section 102, data reception section 118, decryption section 117, BB section 120, and RF section 121.

After the start-up and the settings on the individual blocks in the apparatus are gone through as described above, the various programs stored in the BIOS section 103 or the recording device section 106 are read out through the system control section 102 by the CPU 101, which then starts executing various applications. According to the programs corresponding to the applications thus started, the CPU 101, through the system control section 102, makes the individual block operate.

Now, data representing the operation status of the AV data transmission apparatus 1 is fed from the CPU 101 through the system control section 102 to the display control section 105. Based on this data, the display control section 105 displays the operation status on the display section 107. Moreover, as the input section 109 is operated, control data that instructs the AV data transmission apparatus 1 how to operate is fed through the input control section 108 and the system control section 102 to the CPU 101. Based on this control data, the CPU 101 executes the various programs stored in the BIOS section 103 or the recording device section 106 so that the AV data transmission apparatus 1 operates as instructed.

Furthermore, when a high-frequency signal containing control data is received via the antenna 122, a data packet is fed through the RF section 121 and the BB section 120 to the decryption section 117. The data packet is then decrypted in the decryption section 117, and is then subjected to error correction using error correction codes in the data reception section 118 to obtain control data. Here, the decryption is achieved by the use of an encryption code in the main memory 104. The control data obtained from the data reception section 118 is then fed through the bus line 123 and the system control section 102 to the CPU 101. Based on this control data, the CPU 101 executes the various programs stored in the BIOS section 103 or the recording device section 106 so that the AV data transmission apparatus 1 operates as instructed.

Likewise, in the AV data reception apparatus 2, as in the AV data transmission apparatus 1, when the input section 209 is so operated as to start up, an instruction to that effect is fed through the input control section 208 to the system control section 202, and the CPU 201 makes initial settings according to the programs in the BIOS section 203. Now, data representing the operation status of the AV data reception apparatus 2 is fed from the CPU 201 to the display control section 205, which then displays the operation status on the display section 207. Moreover, as the input section 209 is operated, control data that instructs the AV data reception apparatus 2 how to operate is fed to the CPU 201, and, based on this control data, the CPU 201 executes the various programs stored in the BIOS section 203 so that the AV data reception apparatus 2 operates as instructed.

The AV data transmission and reception apparatuses 1 and 2 described above operate in similar manners to the conventional AV data transmission and reception apparatus 100 and 200. Specifically, video and audio signals are transmitted from the AV data transmission apparatus 1 and are received by AV data reception apparatus 2. On the other hand, control data, ACK signals, and resending request signals are transmitted from the AV data reception apparatus 2 and are received by the AV data transmission apparatus 1. Meanwhile, the video encoding section 111 and the audio encoding section 113 in the AV data transmission apparatus 1 operate in the following manner. In the following descriptions, only the operation of the video encoding section 111 will be described as the representative of those two blocks, and the reference numerals of the correspondingly functioning blocks in the audio encoding section 113 are given in parentheses.

A video (audio) signal from the TV tuner video section 130 or the recording device playback section 131 is directly, or after being converted into a digital signal in the video (audio) AD conversion section 110 (112), fed to the multiplexing section 301 (321). Alternatively, a video (audio) signal from the recording device section 106 is fed through the system control section 102 and the bus line 123 to the multiplexing section 301 (321). In a case where, as here, input from more than one source is possible, the multiplexing section 301 (321) selects the video (audio) signal from the source specified by the CPU 101 through the system control section 102 and the bus line 123.

The video (audio) signal selected by the multiplexing section 301 (321) is then fed to the encrypted copyright cancellation section 302 (322). The encrypted copyright cancellation section 302 (322), by operating according to the firmware stored in the ROM 303 (323) and using the RAM 304 (324), identifies the encrypted copyright method applied to the video (audio) signal and cancels the encrypted copyright signal added thereto.

After the cancellation of the encrypted copyright signal, the video (audio) signal is fed to the video (audio) transcoding section 305 (325). The video (audio) transcoding section 305 (325), by operating according to the firmware stored in the ROM 306 (326) and using the RAM 307 (327), converts the video (audio) signal into a format that can be properly decoded by the video (audio) decoding section 219 (220) and that can be properly reproduced on the display section 207 (audio output section 221) in the AV data reception apparatus 2. Specifically, the video signal is converted into a format that conforms to the compression method, the bit rate, the resolution and the frame rate at playback, and other parameters that are used in the AV data reception apparatus 2; the audio signal is converted into a format that conforms to the compression method, the bit rate, and other parameters that are used in the AV data reception apparatus 2.

After the conversion into the format used in the AV data reception apparatus 2, the video (audio) signal is fed to the encrypted copyright addition section 308 (328), The encrypted copyright addition section 308 (328), by operating according to the firmware stored in the ROM 309 (329) and using the RAM 310 (330), adds to the video (audio) signal an encrypted copyright signal that can be cancelled by the video (audio) decoding section 219 (220) in the AV data reception apparatus 2. That is, here, the video (audio) signal is converted into a video (audio) signal that conforms to the encrypted copyright method used in the AV data reception apparatus 2.

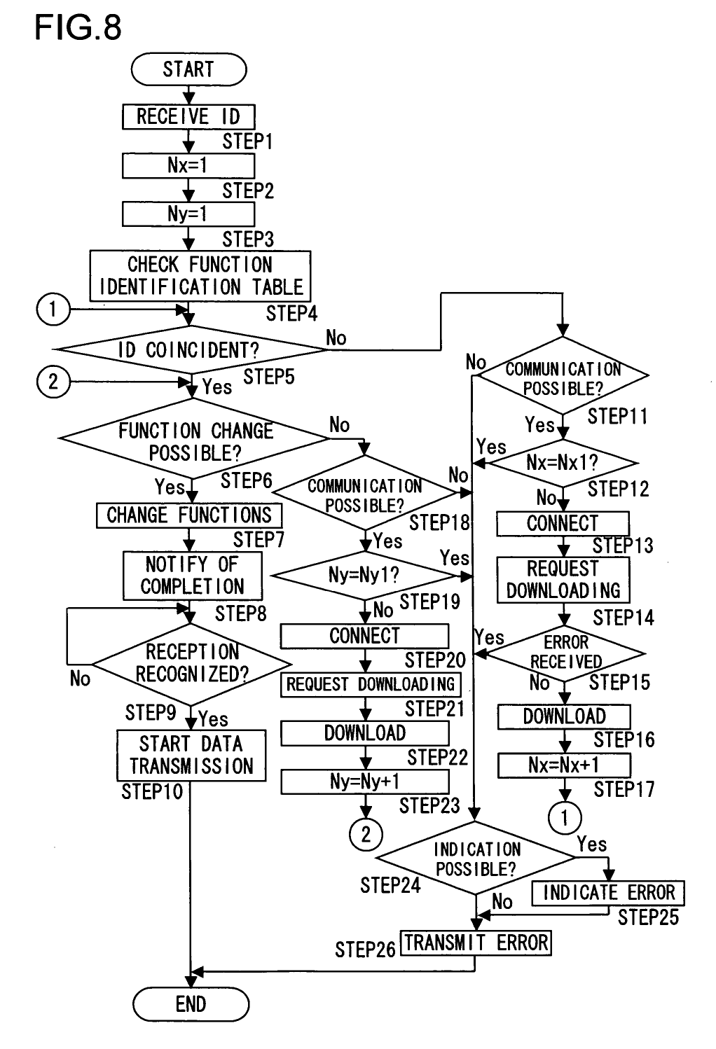

In the AV data wireless communication system provided with the AV data transmission and reception apparatuses 1 and 2 operating as described above, the AV data transmission apparatus 1 needs to operate in a manner that suits the functions of the AV data reception apparatus 2. To achieve this, the AV data transmission apparatus 1 first identifies the functions of the AV data reception apparatus 2, and then makes initial settings on the individual blocks thereof so as to operate by using programs and formats that conform to those functions of the AV data reception apparatus 2. Now, this initial setting operation will be described with reference to the flow chart in FIG. 8.

The AV data reception apparatus 2 permits the AV data transmission apparatus 1 to identify the functions of the AV data reception apparatus 2 itself in the following manner. A model ID that indicates the model of the AV data reception apparatus 2 is stored in the specific data memory 206, and this model ID is read out by the system control section 202, and is then fed through the bus line 222 to the data generation section 216. The data generation section 216 converts the model ID in the specific data memory 206 into a data packet, and then the error correction coding section 217 adds an error correction code thereto.

At this time, the encryption section 218 is instructed not to operate by the CPU 201 through the system control section 202 and the bus line 222. Thus, the data packet having the error correction code added thereto is, without being encrypted in the encryption section 218, converted into a baseband signal in the BB section 212, and is then converted into a high-frequency signal in the RF section 211 so as to be transmitted from the an antenna 210.

When this high-frequency signal containing the model ID, which is not encrypted with the encryption code of the AV data reception apparatus 2, is transmitted, it is received by the AV data transmission apparatus 1 via the antenna 122 thereof (STEP 1). When this high-frequency signal is received, it is converted into a baseband signal in the RF section 121, is then converted into a data packet in the BB section 120, and is then fed to the decryption section 117. The decryption section 117 confirms that the data packet is not encrypted, and then feeds it, without subjecting it to decryption, to the data reception section 118. Then, in the data reception section 118, the data packet is subjected to error correction using error correction codes in the error correction coding section 115, and is then analyzed, so that the model ID of the AV data reception apparatus 2 is recognized and is then fed through the bus line 123 and the system control section 102 to the CPU 101.

When the CPU 101 receives the model ID of the AV data reception apparatus 2, the number Nx of downloading sessions that need to be performed to download the function data corresponding to the model ID is initialized to be 1 (STEP 2), and the number Ny of downloading sessions that need to be preformed to download the software programs to realize the functions corresponding to the function data is initialized to be 1 (STEP 3). These numbers Nx and Ny are stored in the main memory 104.

Then, the CPU 101 reads out a function identification table as shown in FIG. 5 from the individual compatibility information storage section 106a through the system control section 102, and compares it with the received model ID (STEP 4). In the comparison here, the CPU 101 compares the model ID with all the model IDs in the function identification table so as to check whether or not there exists a coincident model ID in the function identification table (STEP 5). Here, the CPU 101 performs the comparison by using the bios section 103 and the main memory 104 through the system control section 102.

If a coincident model ID is found to exist in the function identification table (Yes), the functions of the AV data reception apparatus 2 corresponding to that model ID are identified in the function data, and whether or not it is possible to perform function changing to suit the functions of the AV data reception apparatus 2 is checked (STEP 6). Here, the software program for function changing is stored in the recording device section 106, and therefore, when it is found that it is possible to perform function changing (Yes), function changing is performed according to the functions of the AV data reception apparatus 2 as identified based on the received model ID. How the function changing is performed here will be described in detail later.

At the same time that the transmission functions of the AV data transmission apparatus 1 are being changed so as to suit the reception functions of the AV data reception apparatus 2 as described above, the encryption codes in the main memories 104 and 204 are made coincident with each other by the user directly operating the input section 109 of the AV data transmission apparatus 1 or using a communication medium other than wireless communication between the AV data transmission and reception apparatuses 1 and 2, such as by remote control. These encryption codes are used in wireless communication between the AV data transmission and reception apparatuses 1 and 2.

Thus, on completion of the function changing operation in STEP 7, the system control section 102 generates a function change completion signal to indicate that now the function changing operation is complete and transmission of AV data is possible, and then transmits it to the AV data reception apparatus 2 (STEP 8). Here, the function change completion signal is converted into a data packet in the data generation section 114, then has an error correction code added thereto in the error correction coding section 115, and is then encrypted in the encryption section 116 by the use of the encryption code in the main memory 104. The data packet containing the encrypted function change completion signal is converted into a baseband signal in the BB section 120, and is then converted into a high-frequency signal in the RF section 121, and is then transmitted from the antenna 122.

When this high-frequency signal containing the function change completion signal is received by the AV data reception apparatus 2 via the antenna 210 thereof, it is converted into a data packet through the RF section 211 and the BB section 212, and is ten fed to the decryption section 213. This data packet is then decrypted in the decryption section 213 by using the encryption code in the main memory 204, and is then subjected to error correction in the data reception section 214 by using the error correction codes in the error correction coding section 217. Then, in the data reception section 214, when the obtained data packet is recognized as a function change completion signal, it is fed through the bus line 222 to the system control section 202, so that it is recognized that the function changing operation in the AV data transmission apparatus 1 is now complete, and that AV data communication is now possible. Accordingly, the display control section 205 is so controlled as to indicate, on the display section 207, that AV data communication is possible.

Now that it is recognized that AV data communication is possible in this way, when the user operates the input section 209, such as a remote control unit, to request transmission of AV data, control data that requests transmission of AV data is fed through the input control section 108 to the system control section 202. When this control data is fed through the bus line 222 to the data generation section 216, it has an error correction code added thereto in the error correction coding section 217, is then encrypted in the encryption section 218 by using the encryption code in the main memory 204, and is then transmitted through the BB section 212, the RF section 211, and the an antenna 210.

Thereafter, whether or not a request for transmission of AV data is received from the AV data reception apparatus 2 is checked (STEP 9). If a request for transmission of AV data is received via the antenna 122 (Yes), it is fed through the RF section 121, the BB section 120, and the decryption section 117 to the data reception section 118. Thus, data containing the request for transmission of AV data is fed through the bus line 123 to the system control section 102, which then recognizes it and feeds it to the CPU 101. Now, the CPU 101 controls the operation of the relevant blocks through the system control section 102 to perform AV data transmission operation (STEP 10). Here, the flow does not proceed from STEP 9 to STEP 10 until a request for transmission of AV data is recognized.

If, in STEP 5, no coincident model ID is found in the function identification table (No), whether or not communication with the AV data communication administration server 3 is possible is checked (STEP 11). If communication with the AV data communication administration server 3 is found to be possible by the network control section 125 (Yes), then whether or not the number Nx of downloading sessions that have been performed to download the function data, as identified based on the model ID received in STEP 1, from the AV data communication administration server 3 has exceeded a predetermined value Nx1 is checked (STEP 12).

If, in STEP 12, the number Nx of downloading sessions is found not to have reached the predetermined value Nx1 (No), the network control section 125 controls the network interface 124 to connect to the AV data communication administration server 3 for communication (STEP 13). When the network interface 124 is connected to the AV data communication administration server 3 over the network 4 for communication in this way, downloading of the function data identified based on the model ID recognized in STEP 1 is requested from the network 4 (STEP 14).

At this time, the AV data transmission apparatus 1 feeds the model ID recognized in STEP 1 through the system control section 102 and the bus line 123 to the network control section 125. Then, a function data request signal for requesting the function data identified based on that model ID is generated, and is transmitted from the network interface 124. This function data request signal also contains model data relating to the AV data transmission apparatus 1, i.e., the transmission source. When the function data request signal is received by the AV data communication administration server 3 via the network interface 255 thereof over the network 4, it is fed by the network control section 256 to the system control section 252.

As a result, the system control section 252 recognizes the AV data transmission apparatus 1 that has transmitted the function data request signal, and reads out from the recording device section 257 a function identification table as shown in FIG. 5 that lists the model IDs of AV data reception apparatuses 2 with which the recognized AV data transmission apparatus 1 can communicate along with the corresponding function data. Then, the function data corresponding to the coincident model ID is identified.

Here, when the coincident model ID is found in the function identification table, the corresponding function data is read out, and is fed from the system control section 252 to the network control section 256. If no coincident model ID is found in the function identification table, the system control section 252 generates an error signal and feeds it to the network control section 256. Thereafter, the network control section 256 controls the network interface 255 so that either the function data or the error signal is transmitted to the recognized AV data transmission apparatus 1.

Then, the AV data transmission apparatus 1 checks whether or not an error signal is received from the AV data communication administration server 3 (STEP 15). If the AV data transmission apparatus 1 receives function data (No), it starts to download the function data (STEP 16). Here, the downloaded function data is stored, in the downloaded order, in the function identification table stored in the recording device section 106 of the AV data transmission apparatus 1 itself, and then, when the function data has completely been stored in the function identification table, the model ID obtained in STEP 1 is stored therewith. Here, whether or not the function data has been received normally is checked by adding error detection codes such as CRC (cyclic redundancy check) codes thereto. In this way, the function data corresponding to the AV data reception apparatus 2 is stored in the function identification table of the AV data transmission apparatus 1. Thereafter, the number Nx of downloading sessions is incremented by one (STEP 17).

When the downloading of the function data has been done in this way, the flow returns to STEP 5, where whether or not there exits function data in the function identification table that corresponds to the model ID obtained in STEP 1 is checked again. Here, if, in the downloading performed in STEP 16, the function data has completely been received, it exists in the function identification table, and therefore the operations starting with STEP 6 are performed. By contrast, if the function data has not completely been received, it does not exist in the function identification table, and therefore the operations starting with STEP 11 are performed again.

If, in STEP 6, the software programs corresponding to the identified function data are not held in the rerecording device section 106 (No), as in STEP 11, whether or not communication with the AV data communication administration server 3 is possible is checked by the network control section 125 (STEP 18). If communication with the AV data communication administration server 3 is possible (Yes), as in STEP 12, whether or not the number Ny of downloading sessions that needs to be performed to download the software programs to realize the function has exceeded a predetermined value Ny1 is checked (STEP 19).

If the number Ny of downloading sessions has not reached the predetermined value Ny1 (No), the same operation as in STEP 13 is performed to achieve connection to the AV data communication administration server 3 (STEP 20). Then, downloading of the software programs for realizing the functions corresponding to the function data identified based on the model ID recognized in STEP 1 is requested from the AV data communication administration server 3 (STEP 21). That is, downloading of the software programs for realizing the transmission functions identified based on the model ID as suiting the functions of the AV data reception apparatus 2 is requested.

At this time, a software request signal is generated and transmitted to request downloading of the software programs. Here, the software request signal contains the model ID for identifying the functions and the model data for identifying the AV data transmission apparatus 1. When the AV data communication administration server 3 receives this software request signal, it reads out form the recording device section 257 the software programs for realizing the functions identified based on the software request signal, and transmits them to the AV data transmission apparatus 1.

Then, the AV data transmission apparatus 1 receives the software program transmitted from the AV data communication administration server 3, and starts downloading them (STEP 22). The downloaded software programs are stored in the recording device section 106. Here, whether or not the software programs have been received normally is checked by adding error detection codes such as CRC (cyclic redundancy check) codes thereto. Thereafter, the number Ny of downloading sessions is incremented by one (STEP 23). When the software programs for realizing the functions are downloaded in this way, the flow returns to STEP 6, where whether or not there exit software programs that correspond to the function data identified based on the model ID obtained in STEP 1 is checked. Here, if, in the downloading performed in STEP 22, the software programs have completely been received, the operations starting with STEP 7 are performed. By contrast, if the software programs have not completely been received, the operations starting with STEP 18 are performed again.

If, in STEP 11 or STEP 18, connection cannot be established for communication (No), or if, in STEP 12, the number Nx of downloading sessions is equal to Nx1 (Yes), or if, in STEP 15, an error signal is received (Yes), or if, in STEP 19, the number Ny of downloading sessions Ny equals to Ny1 (Yes), the AV data transmission apparatus 1 examines the programs stored in the BIOS section 103, the main memory 104, the recording device section 106, and the like to check whether or not there is provided a function for indicating an error (STEP 24).

If it is found that there is provided an error indicating function (Yes), an error indication is displayed on the display section 107 (STEP 25). Here, the CPU 101 reads out image data for indicating the error from the recording device section 106, and feeds it to the display control section 105. The display control section 105 then indicates the error by using the image data thus fed thereto.

If, in STEP 24, it is found that there is provided no error indicating function (No), or if, in STEP 25, an error indication is displayed, the system control section 102 generates and transmits an error notification signal for displaying an error indication on the AV data reception apparatus 2, and ends the operation flow. Here, the error notification signal is not encrypted in the encryption section 116. When the AV data reception apparatus 2 receives this error notification signal, it feeds it to the data reception section 214 without decrypting it in the decryption section 213. Thereafter, in a similar manner as when the function change completion signal is received, an error indication is displayed on the display section 207.

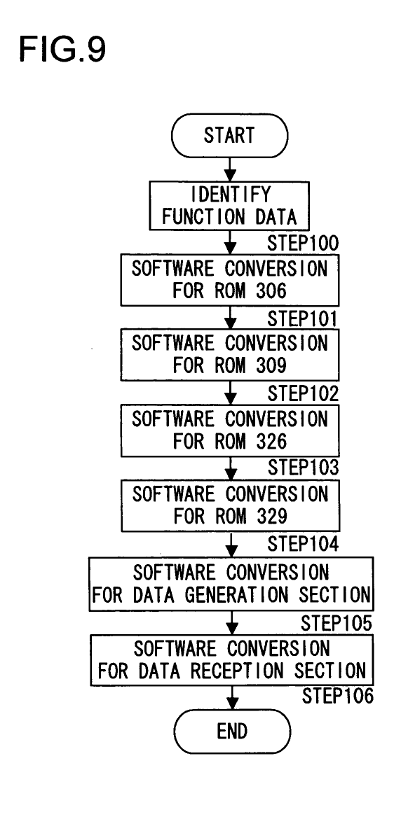

When the initial setting operation is performed according to the flow chart shown in FIG. 8 in this way, the function changing operation in STEP 7 is performed according to the flow chart shown in FIG. 9. Based on the function identification table in the recording device section 106 and the received model ID, the corresponding function data is identified (STEP 100). Specifically, the following parameters used in the AV data reception apparatus 2 corresponding to the received model ID are identified: with respect to the video signal, the compression method, the bit rate, the encrypted copyright method for copyright protection, and the resolution and the frame rate at playback; with respect to the audio signal, the compression method, the bit rate, and the encrypted copyright method for copyright protection; and also the optimum packet length, the remote control method used, etc.

Then, the software program for converting the video signal into a format that is compatible with the compression method, the bit rate, and the resolution and the frame rate at playback used in the AV data reception apparatus 2 corresponding to the received model ID is read out from the recording device section 106 by the system control section 102, and is fed through the bus line 123 to the video encoding section 111 so as to be stored in ROM 306 (STEP 101). That is, the software program by which the video transcoding section 305 can convert the video signal into one that can be processed in the AV data reception apparatus 2 is stored in the ROM 306.

Next, an encrypted copyright signal that is to be added to the video signal handled in the AV data reception apparatus 2 corresponding to the received model ID is read out from the recording device section 106 by the system control section 102, and is then fed through the bus line 123 to the video encoding section 111 so as to be stored in the ROM 309 (STEP 102). That is, the software program by which the encrypted copyright addition section 308 converts the video signal into one treated by the encrypted copyright method that can be handled in the AV data reception apparatus 2 is stored in the ROM 309.

Then, the software program for converting the audio signal into a format that is compatible with the compression method and the bit rate used in the AV data reception apparatus 2 corresponding to the received model ID is read out from the recording device section 106 by the system control section 102, and is fed through the bus line 123 to the audio encoding section 113 so as to be stored in ROM 326 (STEP 103). That is, the software program by which the audio transcoding section 325 can convert the audio signal into one that can be processed in the AV data reception apparatus 2 is stored in the ROM 326.

Furthermore, an encrypted copyright signal that is to be added to the audio signal handled in the AV data reception apparatus 2 corresponding to the received model ID is read out from the recording device section 106 by the system control section 102, and is then fed through the bus line 123 to the audio encoding section 113 so as to be stored in the ROM 329 (STEP 104). That is, the software program by which the encrypted copyright addition section 328 converts the audio signal into one treated by the encrypted copyright method that can be handled in the AV data reception apparatus 2 is stored in the ROM 329.

Then, the software program read out in STEP 100 for generating data packets of the optimum length is stored in the data generation section 114, so that it is now possible to generate data packets of which the packet length is optimal to be handled in the AV data reception apparatus 2 (STEP 105). Thereafter, the software program that permits recognition of control data from the AV data reception apparatus 2 that conforms to the remote control method used there is stored in the data reception section 118 (STEP 106). In this way, in the data reception section 118, it is now possible to recognize the control data received from the AV data reception apparatus 2 to control the operation of the AV data transmission apparatus 1.

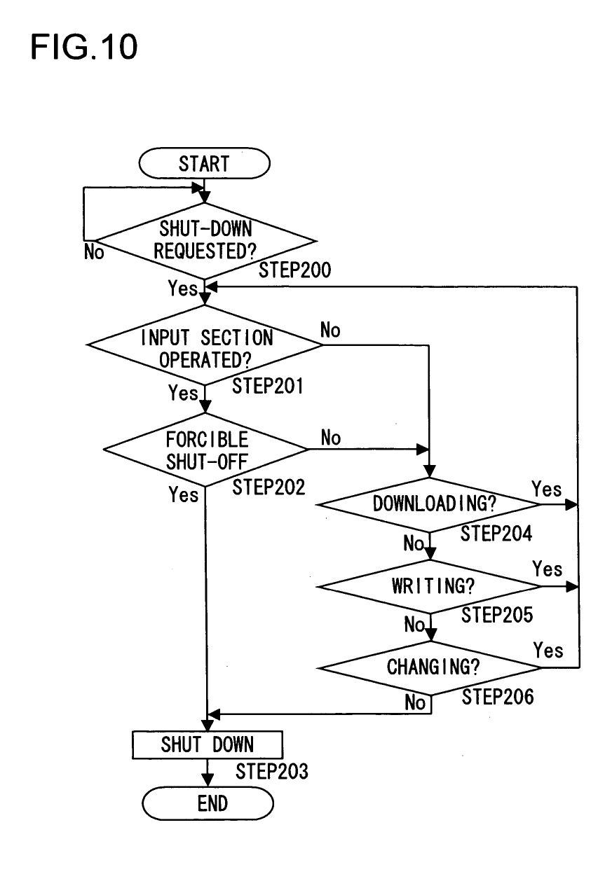

In this way, by operating according to the flow charts shown in FIGS. 8 and 9, the AV data transmission apparatus 1 changes its functions to those which suit the functions of the AV data reception apparatus 2. Now, with reference to the flow chart shown in FIG. 10, a description will be given of the operation performed when, during the operation described above, the AV data transmission apparatus 1 is so operated as to shut down.

In the AV data transmission apparatus 1, the system control section 102 checks whether or not shutting-down is requested through the operation of the input section 109, or through the reception of control data from the AV data reception apparatus 2, or with a timer setting in the system control section 102 (STEP 200). Here, when the input section 109 is operated, the operation is fed to the system control section 102 through the input section 109. Alternatively, when the input section 209 of the AV data reception apparatus 2 is operated, the operation is transmitted, in the same manner as other control data is, to the AV data transmission apparatus 1, and, when this control data is received via the antenna 122, it is analyzed in the data reception section 118, and is then fed through the bus line 123 to the system control section 102. Alternatively, when a timer setting for shutting-down is made in advance through the operation of the input section 109 or otherwise, whether or not the time to shut down has come is checked by referring to the timer in the system control section 102.

When a request for shutting-down is recognized (Yes), whether or not it is requested through the operation of the input section 109 is checked (STEP 201). If, in STEP 200, no request for shutting-down is recognized (No), whether or not shutting-down is requested is checked again. Here, the operation in STEP 200 is performed at predetermined time intervals. If, in STEP 201, the request is found to be made through the operation of the input section 109 (Yes), whether or not predetermined operation is performed on the input section 109 to request forcible shutting-down is checked (STEP 202). Here, the predetermined operation is, for example, keeping the key for requesting shutting-down pressed for a predetermined length of time or more or pressing that key along with another key.

When, as a result of the predetermined operation, a request for forcible shutting-down is recognized by the system control section 102 through the input control section 108 (Yes), the CPU 101 performs the operation for shutting-down (STEP 203). If, in STEP 201, the request for shutting-down is found not to be made through the operation of the input section 109 (No), or if, in STEP 202, the predetermined operation is not performed (No), the status of the network interface 124 is checked through the network control section 125 to check whether or not function data or a software program is being downloaded (STEP 204).

If the network interface 124 is found not to be performing communication, i.e., not to be performing downloading operation (No), the status of the recording device section 106 is checked to check whether or not downloaded function data or a downloaded software program is being written is checked (STEP 205). If no wringing operation is found to be being performed on the recording device section 106, i.e., if no registration of downloaded function data or software program is found to be being performed (No), whether or not function changing operation is being performed to adapt to the functions of the AV data reception apparatus 2 is checked (STEP 206).

If no function changing operation to adapt to the functions of the AV data reception apparatus 2 is found to be being performed (No), the flow proceeds to STEP 203, where the operation for shutting-down is performed. If, in STEP 204, downloading operating is found to be being performed (Yes), or if, in STEP 205, registering operation is found to be being performed (Yes), or if, in STEP 206, function changing operation is found to be being performed (Yes), then the flow proceeds to STEP 201, where whether or not shutting-off is requested through the operation of the input section 109 is checked. Accordingly, until the initial setting operation performed according to the flow charts shown in FIGS. 8 and 9 is complete, even when shutting-down is requested, it is not effected unless forcible shitting-down is requested.

In this embodiment, before any function data or software programs are added by being downloaded, function data and software programs that are to be stored in the individual compatibility information storage section 106a and the recording device section 106 may be stored in advance as original data in a fixed, write-disabled region. Alternatively, a recording region in which to temporarily store downloaded function data and software programs may be provided in the individual compatibility information storage section 106a and the recording device section 106 so that, on completion of their downloading, they are stored additionally in the region in which already stored function data and software programs are stored.

In this embodiment, downloaded software programs are stored in the recording device section 106. It is, however, also possible to store them in the BIOS section 103 and the data generation section 114. Alternatively, the individual compatibility information storage section 106a may be provided as part of the BIOS section 103, recording device section 106, and data generation section 114.

In this embodiment, communication is performed without using an encryption code until the completion of the initial setting operation for changing the functions of the AV data transmission apparatus 1 to those which suit the functions of the AV data reception apparatus 2 and thus until the transmission of the function change completion signal. Instead, it is possible to first make coincident the encryption code used between the AV data transmission and reception apparatuses 1 and 2 and then perform the initial setting operation so that communication is performed between the AV data transmission and reception apparatuses 1 and 2 by using that encryption code. Alternatively, a common encryption code for performing the initial setting operation may be stored in the AV data transmission and reception apparatuses 1 and 2 so that the initial setting operation is performed by using that encryption code.

Second Embodiment

A second embodiment of the present invention will be described below with reference to the drawings. In this embodiment, an AV data wireless communication system is configured as shown in FIG. 1, and the AV data transmission apparatus, AV data reception apparatus, and AV data communication administration servers used therein are configured as shown in FIGS. 2 to 4, i.e., as in the first embodiment. Here, the exchange of AV data and control data between the AV data transmission and reception apparatuses is performed in the same manner as in the first embodiment.

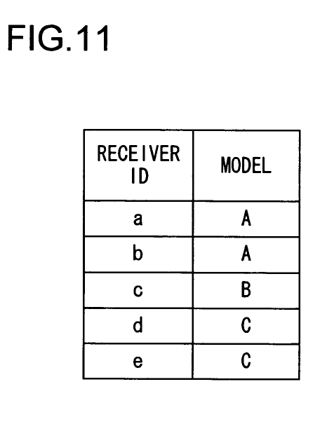

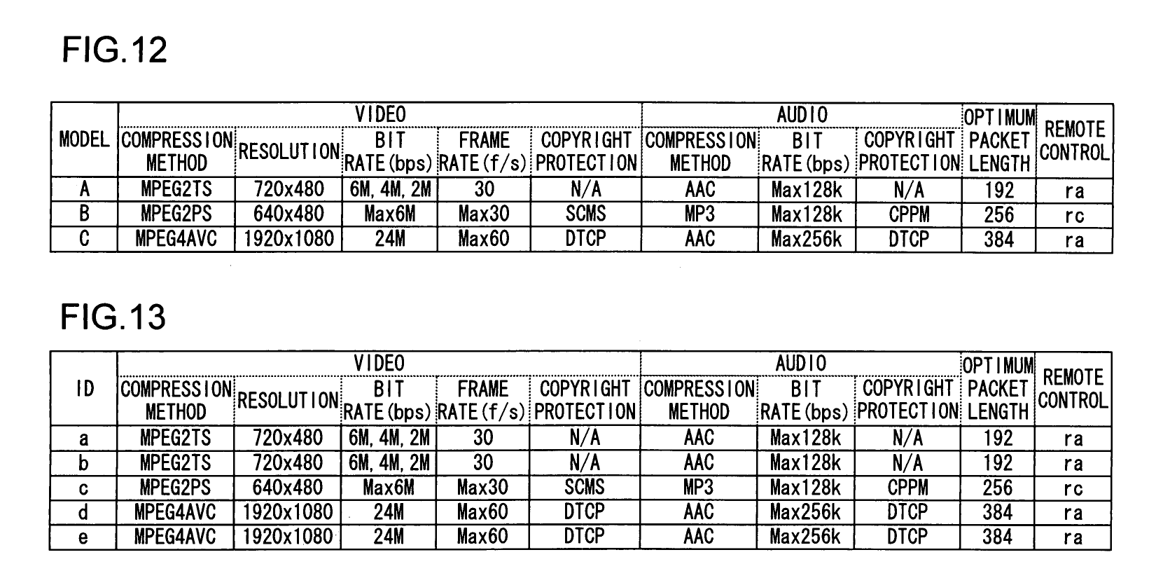

In the first embodiment, the model ID that the AV data reception apparatus 2 transmits to permit the model thereof to be identified is stored in the specific data memory, 206. By contrast, in this embodiment, an apparatus ID assigned to each AV data reception apparatus 2 to permit the individual apparatus to be identified is stored in the specific data memory 206. Moreover, an apparatus ID is assigned also to each AV data transmission apparatus 1, and this apparatus ID is stored in the individual compatibility information storage section 106a. Correspondingly, in the AV data communication administration server 3, there are stored in the recording device section 257 a model identification table as shown in FIG. 11 in which are registered, for the apparatus ID of each AV data transmission apparatus 1, the apparatus IDs and models of AV data reception apparatuses with which that AV data transmission apparatus 1 is permitted to communicate and a function identification table as shown in FIG. 12 in which is registered the function data corresponding to each model identified with reference to the model identification table shown in FIG. 12.

Specifically, the model identification table shown in FIG. 11 permits the AV data transmission apparatus 1 of which the apparatus ID is “X” to communicate with the AV data reception apparatuses 2 of which the apparatus IDs are “a” to “e,” and in addition indicates that the model of the AV data reception apparatuses 2 of which the apparatus IDs are “a” and “b” is “A,”, the model of the AV data reception apparatus 2 of which the apparatus ID is “b” is “B,” and the model of the AV data reception apparatuses 2 of which the apparatus ID is “d” and “e” is “C.”

On the other hand, in the function identification table shown in FIG. 12, as in the function identification table shown in FIG. 5, there are stored, for each of the models “A” to “C” of the AV data reception apparatuses 2, the following parameters as the function data thereof: with respect to the video signal, the compression method, the bit rate, the encrypted copyright method for copyright protection, and the resolution and the frame rate at playback; with respect to the audio signal, the compression method, the bit rate, and the encrypted copyright method for copyright protection; and also the optimum packet length, the remote control method used, etc.

In this embodiment, in the function identification table stored in the recording device section 106 as of the AV data transmission apparatus 1, there may be registered, instead of function data for each model ID as in the first embodiment, function data for each apparatus ID as shown in FIG. 13. Likewise, in the recording device section 257 of the AV data communication administration server 3, there may be stored a model identification table as shown in FIG. 11 in combination with a function identification table as shown in FIG. 12, or a function identification table as shown in FIG. 13.

With the individual tables stored in the AV data transmission apparatus 1 and the AV data communication administration server 3 configured as described above, the initial setting operation is performed according to the flow charts shown in FIGS. 8 and 9 as in the first embodiment. Here, however, as opposed to in the first embodiment, the AV data reception apparatus 2 transmits an apparatus ID instead of a model ID, and accordingly, in STEP 1, the apparatus ID of the AV data reception apparatus 2 is recognized. Then, in STEPs 4 and 5, the received apparatus ID is compared with the apparatus IDs in the model identification table shown in FIG. 11 or those in the function identification table shown in FIG. 13 in the individual compatibility information storage section 106a in order to cheek whether or not there exists a coincident apparatus ID.

If, in STEP 5, the apparatus ID received in STEP 1 is found to be coincident with one of the apparatus IDs in the individual compatibility information storage section 106a, the AV data reception apparatus 2 is recognized as an AV data reception apparatus 2 with which communication is permitted, and therefore the operations starting with STEP 6 are performed. The operations starting with STEP 6 are performed in the same manner as in the first embodiment, and therefore no further explanations will be given thereof If, in STEP 5, it is found that there exists no coincident apparatus ID, the operations of STEPs 11 and 12 are performed. At this time, if communication with the AV data communication administration server 3 is possible and in addition the number Nx of downloading sessions has not reached Nx1, then, in STEP 13, connection with the AV data communication administration server 3 is established for communication, and then, in STEP 14, a function data request signal is transmitted that contains the apparatus ID of the AV data transmission apparatus 1 itself and the apparatus ID of the AV data reception apparatus 2 as received in STEP 1.

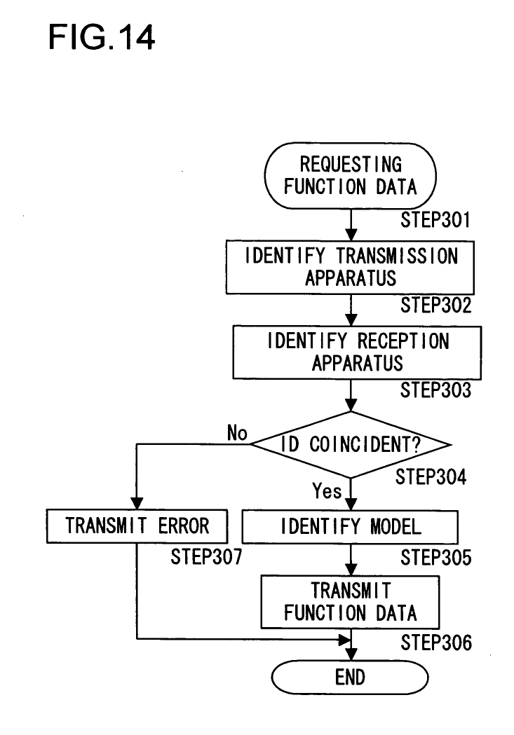

When this function data request signal is received by the AV data communication administration server 3, the system control section 252 operates according to the flow chart shown in FIG. 14 to read out the function data of the AV data reception apparatus 2. In the following description, it is assumed that the AV data communication administration server 3 is provided with the model identification table shown in FIG. 11 and the function identification table shown in FIG. 12. First, when the function data request signal is received (STEP 301), based on the apparatus ID of the AV data transmission apparatus 1, the AV data transmission apparatus 1 that is requesting function data is identified (STEP 302).

Then, the apparatus ID of each of the AV data reception apparatuses 2 with which the thus identified AV data transmission apparatus 1 is permitted to communicate is read out from the model identification table, and is compared with the apparatus ID of the AV data reception apparatus 2 contained in the function data request signal (STEP 303). Here, whether or not, among the apparatus IDs of the AV data reception apparatuses 2 with which the AV data transmission apparatus 1 is permitted to communicate, there is any that is coincident with the apparatus ID of the AV data reception apparatus 2 as recognized from the function data request signal (STEP 304) is checked.

If the apparatus ID of the AV data reception apparatus 2 as recognized in the function data request signal coincides with one of the apparatus IDs of the AV data reception apparatuses 2 with which communication is permitted (Yes), the model corresponding to that apparatus ID is identified with reference to the model identification table (STEP 305). Then, the function data corresponding to the model identified with reference to the model identification table is read out from the function identification table in the recording device section 257, and is transmitted from the network interface 255 to the AV data transmission apparatus 1 (STEP 306). If, in STEP 304, no apparatus ID that is coincident with the apparatus ID of the AV data reception apparatus 2 as recognized in the function data request signal is identified with reference to the model identification table (No), the system control section 252 generates an error signal, which is then transmitted from the network interface 255 (STEP 307).

When the error signal or function data is transmitted from the AV data communication administration server 3, in the AV data transmission apparatus 1, whether or not an error signal is received is checked in STEP 15. The operations starting with STEP 15 are performed in the same manner as in the first embodiment, and therefore no further explanations will be given thereof

With function data administered on the basis of apparatus IDs in this way, the AV data transmission apparatus 1 can administer, on an apparatus-by-apparatus basis, the AV data reception apparatuses 2 with which it is permitted to communicate. Moreover, the AV data communication administration server 3 can also administer, on an apparatus-by-apparatus basis, the AV data reception apparatuses 2 with which each AV data transmission apparatus 1 is permitted to communicate.

Here, for example, the system may be so operated that, when the distributor that sold the AV data reception apparatus 2 or the user who bought it transmits over the network 4 to the AV data communication administration server 3 the apparatus ID of the AV data transmission apparatus 1 with which the sold or bought AV data reception apparatus 2 needs to be permitted to communicate along with the apparatus ID and the model of the AV data reception apparatus 2 itself, the corresponding data is additionally registered in the model identification table in the AV data communication administration server 3.

The model identification table may be so configured as to achieve user-by-user administration. In that case, when an ID that identifies a user and the apparatus ID of the AV data transmission or reception apparatus 1 or 2 that the user bought are transmitted to the AV data communication administration server 3, communication between the AV data transmission and reception apparatuses 1 and 2 that the user possesses is permitted. To achieves this, in the model identification table are registered, for the apparatus ID of each AV data transmission apparatus 1 that the user possesses, the apparatus ID and the model of each AV data reception apparatus 2 that the same user possesses.

Third Embodiment

A third embodiment of the present invention will be described below with reference to the drawings. In this embodiment, an AV data wireless communication system is configured as shown in FIG. 1, and the AV data transmission apparatus, AV data reception apparatus, and AV data communication administration servers used therein are configured as shown in FIGS. 2 to 4, i.e., as in the first embodiment. Here, the exchange of AV data and control data between the AV data transmission and reception apparatuses is performed in the same manner as in the first embodiment. In this embodiment, as in the second embodiment, apparatus IDs are stored in the AV data transmission and reception apparatuses 1 and 2.

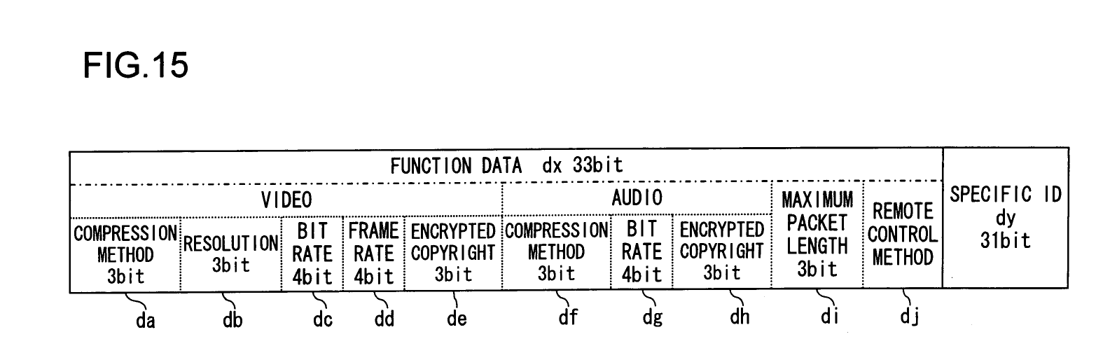

In this embodiment, the apparatus ID of the AV data reception apparatus 2 consists of, for example, 64 bits as shown in FIG. 15, with its upper 33-bit data segment “dx” serving as function data by which the functions of the AV data reception apparatus 2 are identified, and its lower 31-bit data segment “dy” serving as an individual ID assigned to each individual AV data reception apparatus 2. The upper 33 bits of the apparatus ID, i.e., the function data, consists of: a 3-bit functional condition data segment “da” that represents the compression method of the video signal; a 3-bit functional condition data segment “db” that represents the resolution at playback; a 4-bit functional condition data segment “dc” that represents the bit rate of the video signal; a 4-bit functional condition data segment “dd” that represents the frame rate at playback; a 3-bit functional condition data segment “de” that represents the encrypted copyright method of the video signal; a 3-bit functional condition data segment “df” that represents the compression method of the audio signal; a 4-bit functional condition data segment “dg” that represents the bit rate of the audio signal; a 3-bit functional condition data segment “dh” that represents the encrypted copyright method of the audio signal; a 3-bit functional condition data segment “di” that represents the optimum packet length; and a 3-bit functional condition data segment “dj” that represents the remote control method.

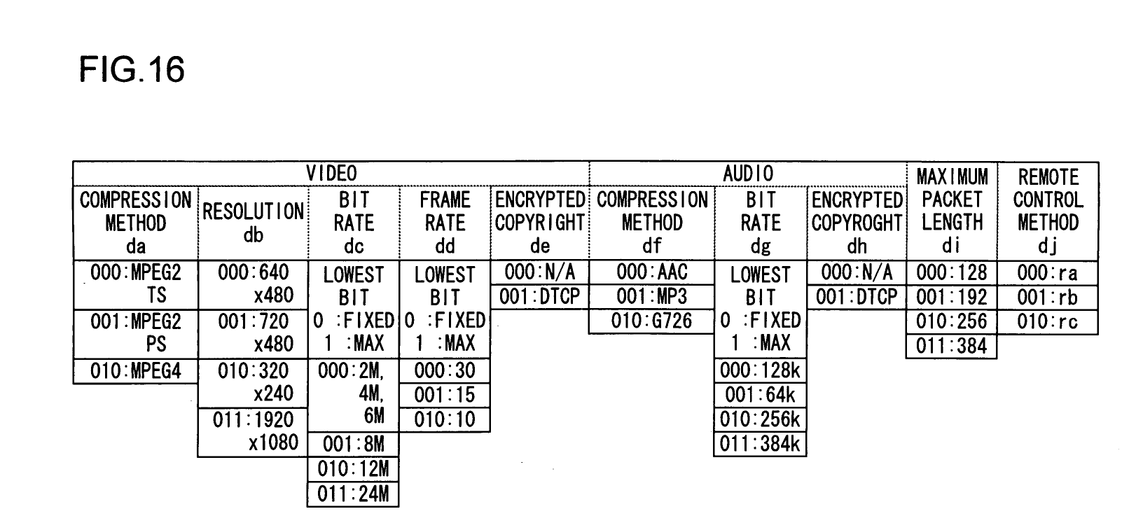

Moreover, the AV data transmission apparatus 1 is provided with, in the recording device section 106 thereof, a function identification table as shown in FIG. 16, in which are registered all the possible codes for each of the functional condition data segments “da” to “dj” along with the functional conditions they represent, and a permitted apparatus table, in which are registered the individual IDs “dy” of all the AV data reception apparatus 2 with which the AV data transmission apparatus 1 is permitted to communicate. For example, in the function identification table shown in FIG. 16, with respect to the functional condition data segment “da,” “000” represents the MPEG2_TS compression method, “001” represents the MPEG2_PS compression method, and “010” represents the MPEG4 compression method. Likewise, with respect to each of the other functional condition data segments “db” to “dj,” different codes represent different functional conditions.

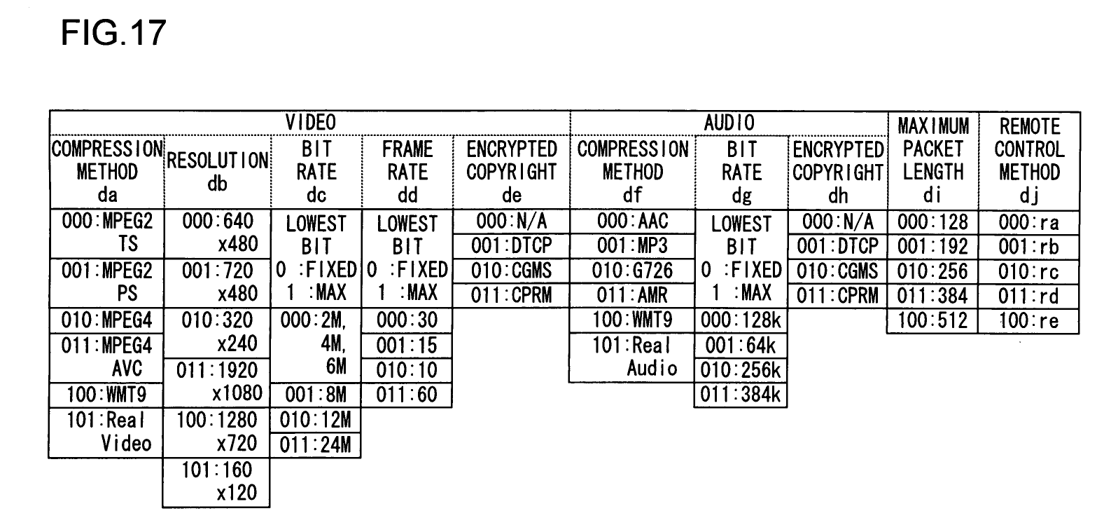

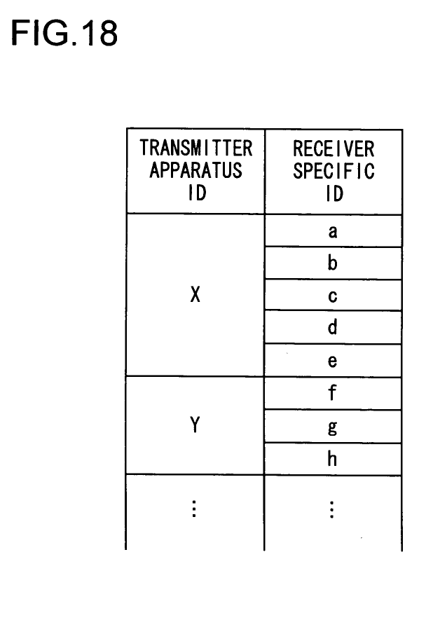

On the other hand, in the recording device section 257 of the AV data communication administration server 3, there are recorded a function identification table as shown in FIG. 17, which is similar to that shown in FIG. 16, and a permitted apparatus table as shown in FIG. 18, in which are stored the individual IDs of all the AV data reception apparatuses 2 with which each AV data transmission apparatus 1 is permitted to communicate. In the function identification table shown in FIG. 17, the number of codes recorded for each of the functional condition data segments “da” to “dj” is larger than the number of corresponding codes recorded in the function identification table shown in FIG. 16. This permits a larger number of different conditions to be registered for each function.

Likewise, in the permitted apparatus table shown in FIG. 18, the number of individual IDs of the AV data reception apparatuses 2 that are stored for each apparatus ID of the AV data transmission apparatus is lager than the number of individual IDs in the permitted apparatus table stored in each AV data transmission apparatus 1. In the permitted apparatus table shown in FIG. 18, it is assumed that the AV data transmission apparatus 1 of which the apparatus ID is “X” is permitted to communicate with the AV data reception apparatuses 2 of which the individual IDs are “a” to “e.”

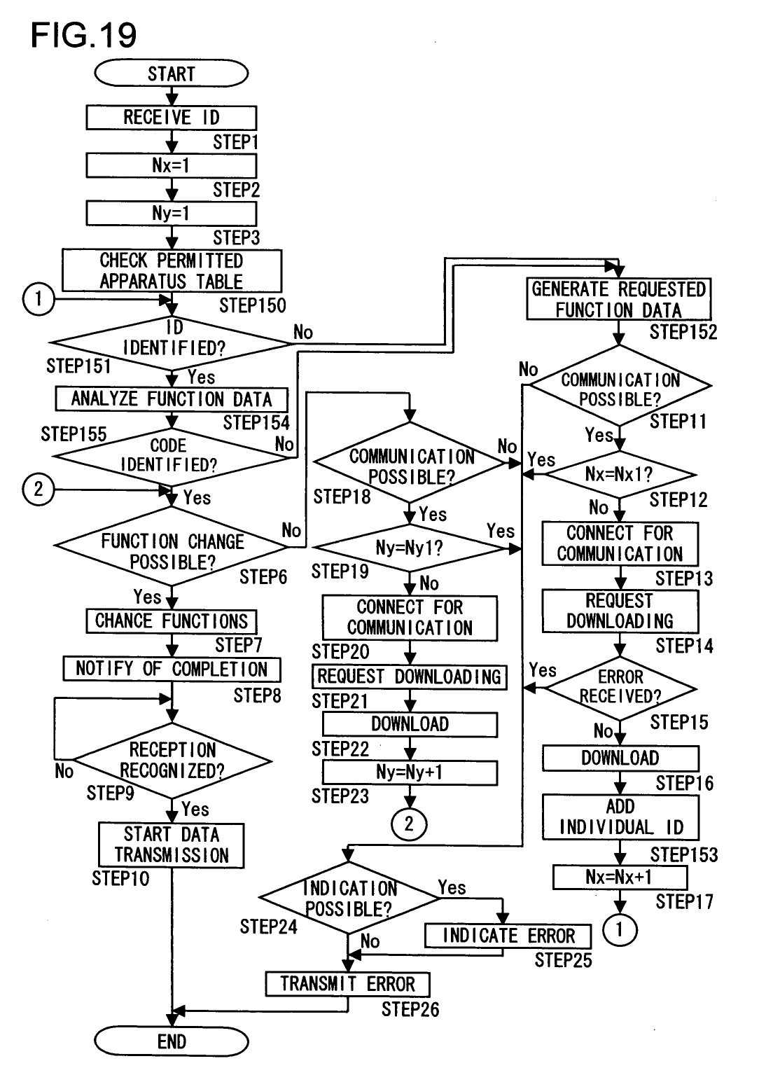

Here, the AV data transmission apparatus 1 performs the initial setting operation according to the flow chart shown in FIG. 19 to convert its functions to those which suit the functions of the AV data reception apparatus 2. In the flow chart shown in FIG. 19, such steps in which the same operations as in FIG. 8 are performed are identified with the same step numbers, and their detailed explanations will not be repeated. Moreover, in this embodiment, the AV data reception apparatuses 2 are administered not based on their model IDs, i.e., on a model-by-model basis, as in the first embodiment but based on their individual IDs, which correspond to the apparatus IDs in the second embodiment, i.e., on an apparatus-by-apparatus basis. Thus, here, the AV data transmission apparatus 1 operates basically as in the second embodiment.

First, in the AV data reception apparatus 2, the apparatus ID stored in the specific data memory 206 is read out, is converted into a high-frequency signal, and is transmitted. This high-frequency signal is received by the AV data transmission apparatus 1, and the apparatus ID contained therein is identified in the data reception section 118 (STEP 1). Then, in STEPs 2 and 3, as in the first and second embodiments, the numbers Nx and Ny of downloading sessions are initialized.

When the apparatus ID received in STEP 1 is fed through the bus line 123 to the system control section 102, it is fed to the main memory 104 and is stored therein. In the system control section 102, the individual ID contained in this apparatus ID is compared with the individual IDs recorded in the permitted apparatus table in the individual compatibility information storage section 106a (STEP 150). Then, whether or not there exits, in the permitted apparatus table in the individual compatibility information storage section 106a, an individual ID that is coincident with the individual ID obtained from the apparatus ID received in STEP 1 is checked (STEP 151).

If it is found that there exists no coincident individual ID in the permitted apparatus table (No), among the individual functional condition data segments “da” to “dj” of the function data contained in the apparatus ID temporarily stored in the main memory 104, any functional condition data segment “d1” (here, “d1” represents one or more of “da” to “dj”) that contains a code that is not registered in the function identification table in the individual compatibility information storage section 106a is identified, and this functional condition data segment “d1” and that unregistered code are stored as requested function data in the main memory 104 (STEP 152).

Thereafter, as in the second embodiment, in STEPs 11 and 12, if communicating with the AV data communication administration server 3 is possible and in addition if the number Nx of downloading sessions has not reached Nx1, then, in STEP 13, connection with the AV data communication administration server 3 is established. Then, in STEP 14, the requested function data and the individual ID stored in the main memory 104 are read out, and a function data request signal containing the requested function data, the individual ID, and the apparatus ID of the AV data transmission apparatus 1 itself is generated in the system control section 102 and is then transmitted from the network interface 124 through the network control section 125.

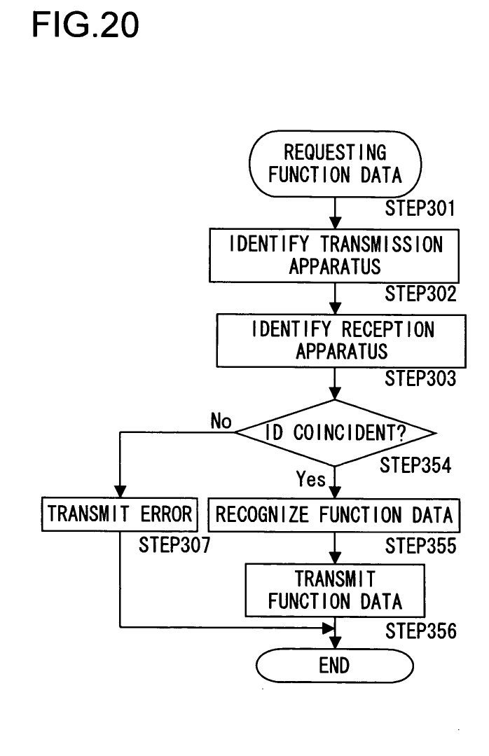

When this function data request signal is received by the AV data communication administration server 3, as in the second embodiment, the system control section 252 performs operations according to the flow chart shown in FIG. 20 to read out the function data of the AV data reception apparatus 2. In the flow chart shown in FIG. 20, such steps in which the same operations as in the flow chart shown in FIG. 14 are performed are identified with the same step numbers, and their detailed explanations will not be repeated. First, in STEPs 301 and 302, the function data request signal is received, and the AV data transmission apparatus 1 is identified based on the apparatus ID.

Then, from the permitted apparatus table as shown in FIG. 18, the individual ID of each of the AV data reception apparatuses 2 with which the thus identified AV data transmission apparatus 1 is permitted to communicate is read out, and the individual ID of the AV data reception apparatus 2 as recognized from on the received function data request signal is compared therewith (STEP 303). Here, whether or not, among the individual IDs of the AV data reception apparatuses 2 with which the AV data transmission apparatus 1 is permitted to communicate as known from the permitted apparatus table, there is any that is coincident with the individual ID of the AV data reception apparatus 2 as recognized from the received function data request signal is checked (STEP 354).

Here, if it is found that the individual ID of the AV data reception apparatus 2 as recognized from the received function data request signal is coincident with one of the individual IDs of the AV data reception apparatuses 2 with which communication is permitted (Yes), the requested function data contained in the function data request signal is recognized (STEP 355). Then, the functional condition represented by the functional condition data segment “d1” contained in the requested function data is read out from the function identification table as shown in FIG. 17, and is transmitted from the network interface 255 to the AV data transmission apparatus 1 (STEP 356). Each functional condition thus read out is transmitted in association with the corresponding functional condition data segment “d1” and the code thereof contained in the requested faction data. On the other hand, if, in STEP 354, it is found that there exists no individual ID that is coincident with the individual ID of the AV data reception apparatus 2 as recognized from the function data request signal (No), an error signal is transmitted as in STEP 307.

When the error signal or the functional condition read out is transmitted from the AV data communication administration server 3, then, in the AV data transmission apparatus 1, whether or not an error signal is received is checked in STEP 15. If, in STEP 15, no error signal is received (No), the functional condition received from the AV data communication administration server 3 as corresponding to the unregistered code of each functional condition data segment “d1” is recognized, and the thus recognized functional condition is, along with the code of the functional condition data segment “d1” that represents it, additionally stored in the function identification table as shown in FIG. 16 in the individual compatibility information storage section 106a (STEP 16). Thereafter, the individual ID stored in the main memory 104 is additionally stored in the permitted apparatus table in the individual compatibility information storage section 106a (STEP 153), and then the number Nx of downloading sessions is incremented by one (STEP 17). Then, the flow proceeds to STEP 151.

More specifically, the operations described above proceed in the following manner. Assume now that, for example, in the individual compatibility information storage section 106a of the AV data transmission apparatus 1 of which the apparatus ID is “X” are stored a function identification table as shown in FIG. 16 and a permitted apparatus table in which are stored individual IDs “a” to “c” as those of the AV data reception apparatuses 2 with which communication is permitted. Moreover, assume also that, when the AV data reception apparatus 2 of which the individual ID is “d” transmits an apparatus ID, the apparatus ID contains, as function data, “011 100 1011 1001 001 011 0010 001 100 000,” such that the functional condition data segments “da” to “dj” are “011” “100” “1011” “1001” “001” “011” “0010” “001” “100” “000,” respectively.

When this apparatus ID is received by the AV data transmission apparatus 1, the individual ID “d” contained in the received apparatus ID of the AV data reception apparatus 2 is compared with the individual IDs “a” to “c” stored in the permitted apparatus table, with the result that it is found that there exists no coincident individual ID. Then, whether or not the code of each of the functional condition data segments “da” to “dj” is registered in the function identification table shown in FIG. 16 is checked.

Now, it is found that no conditions are registered in the function identification table shown in FIG. 16 that correspond to the code “011” of the functional condition data segment “da,” the code “100” of the functional condition data segment “db,” the code “011” of the functional condition data segment “df,” and the code “100” of the functional condition data segment “di.” Thus, these functional condition data segments “da,” “db,” “df,” and “di,” along with their respective codes “011,” “100,” “011,” and “100,” are treated as requested function data. Then, a function data request signal containing that requested function data, the apparatus ID “X” of the AV data transmission apparatus 1, and the individual ID “d” of the AV data reception apparatus 2 is transmitted.

When this function data request signal is received by the AV data communication administration server 3, with reference to the permitted apparatus table shown in FIG. 18, it is recognized that the individual IDs of the AV data reception apparatuses 2 with which the AV data transmission apparatus 1 of which the apparatus ID “X” is recognized from the function data request signal is permitted to communicate are “a” to “e.” Thus, the individual IDs “a” to “e” recognized with reference to the permitted apparatus table shown in FIG. 18 include the individual ID “d” contained in the function data request signal, and accordingly it is now recognized that the AV data transmission apparatus 1 of which the apparatus ID is “X” is permitted to communicate with the AV data reception apparatus 2 of which the individual ID is “d.”

Then, based on the requested function data recognized from the function data request signal, it is recognized that it is necessary to request the conditions corresponding to the codes “011,” “100,” “011,” and “100” of the functional condition data segments “da,” “db,” “df,” and “di,” respectively. These functional condition data segments “da,” “db,” “df,” and “di” and their respective codes “011,” “100,” “011,” and “100” are checked against the function identification table shown in FIG. 17 to identify the corresponding functional conditions. Specifically, the compression method for the video signal is identified as the MPEG4_AVC method, the resolution as 1,280×720, the compression method for the audio signal as the AMR method, and the optimum packet length as 512 bits.

When the functional conditions corresponding to the codes “011,” “100,” “011,” and “100” of the functional condition data segments “da,” “db,” “df,” and “di,” respectively, are identified in this way, these functional conditions are, along with the functional condition data segments “da,” “db,” “df,” and “di” and their respective codes “011,” “100,” “011,” and “100,” transmitted to the AV data transmission apparatus 1. Thus, in the AV data transmission apparatus 1, the individual ID “d” of the AV data reception apparatus 2 stored in the main memory 104 is additionally registered in the permitted apparatus table, and the functional conditions “MPEG4_AVC method,” “1,280×720,” “AMR method,” and “512 bits” corresponding to the codes “011,” “100,” “011,” and “100” of the functional condition data segments “da,” “db,” “df,” and “di,” respectively, are additionally registered in the function identification table shown in FIG. 16.

If, in STEP 151, it is found that there exists a coincident individual ID in the permitted apparatus table (Yes), the functional condition data segments “da” to “dj” contained in the apparatus ID stored in the main memory 104 are analyzed by the system control section 102 (STEP 154). Then, whether or not the codes of the functional condition data segments “da” to “dj” contained in the apparatus ID are registered in the function identification table in the individual compatibility information storage section 106a and thus whether or not the corresponding functional conditions can be identified is checked (STEP 155). Here, if it is found that, among the functional condition data segments contained in the apparatus ID, there exists any of which the code is not registered in the function identification table and for which the functional condition thus cannot be identified (No), the operations starting with STEP 152 are performed.

If all the codes of the functional condition data segments “da” to “dj” contained in the apparatus ID are registered and thus the corresponding functional conditions can all be identified (Yes), the operations starting with STEP 6 are performed. The operations starting with STEP 6 are preformed in the same manner as in the second embodiment, and therefore their detailed explanations will not be repeated.

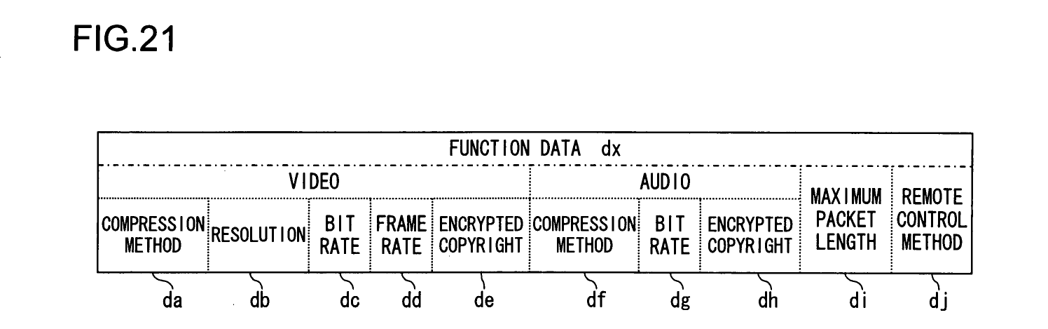

The function data contained in the apparatus ID shown in FIG. 15 of the AV data reception apparatus 2 may be dealt with as separate additional data so that the apparatus ID consists solely of the individual ID. In that case, the function data in the apparatus ID shown in FIG. 15 may be dealt with separately as function addition data as shown in FIG. 21 that is transmitted separately from the apparatus ID. Specifically, only the function addition data shown in FIG. 21 is transmitted from the AV data reception apparatus 2 to the AV data transmission apparatus 1, and the AV data transmission apparatus 1 performs the operations shown in the flow chart of FIG. 19 excluding STEPs 150 and 151 to perform the initial setting operations for function changing. Here, the codes of the functional condition data segments contained in the function addition data are analyzed in STEP 154, and whether or not those codes are registered is checked in STEP 155.

Alternatively, the function addition data shown in FIG. 21 and the apparatus ID may both be transmitted to the AV data transmission apparatus 1. In that case, in STEPs 150 and 151, as in the second embodiment, the apparatus ID of the AV data reception apparatus 2 is checked in order to check whether or not the AV data reception apparatus 2 is one with which communication is permitted. In STEPs 154 and 155, the codes of the functional condition data segments in the function addition data are checked.

If the code of any functional condition data segment recognized from the requested function data in the function data request signal received by the AV data communication administration server 3 is not registered in the function identification table in the recording device section 257, an error signal may be transmitted to the AV data transmission apparatus 1. The AV data communication administration server 3 may be so configured that, when a AV data reception apparatus 2 provided with new functional conditions is manufactured, the codes for adapting to those new functional conditions are registered in the function identification table in the recording device section 257 so as to correspond to the functional condition data segments. Fourth Embodiment

A fourth embodiment of the present invention will be described below with reference to the drawings. In this embodiment, an AV data wireless communication system is configured as shown in FIG. 1, and the AV data transmission apparatus, AV data reception apparatus, and AV data communication administration servers used therein are configured as shown in FIGS. 2 to 4, i.e., as in the first embodiment. Here, the exchange of AV data and control data between the AV data transmission and reception apparatuses is performed in the same manner as in the first to third embodiments, and the initial setting operation for function changing are performed in the same manner as in the first or second embodiments.

In this embodiment, the AV data reception apparatus 2 of which the functional conditions can be changed is provided with, in the specific data memory 206 thereof, a plurality of model IDs or apparatus IDs. In the following description, it is assumed that model IDs are used as in the first embodiment. The model IDs stored in the specific data memory 206 of the AV data reception apparatus 2 in this way are set so as to correspond to different sets of functional conditions. Specifically, for example, in a case where the compression method of the video signal can be chosen between the MPEG2_TS and MPEG2_PS methods and the resolution at playback can be chosen among 320×240, 640×480, and 720×480, there are provided six model IDs that correspond to six different combinations of those functional conditions.

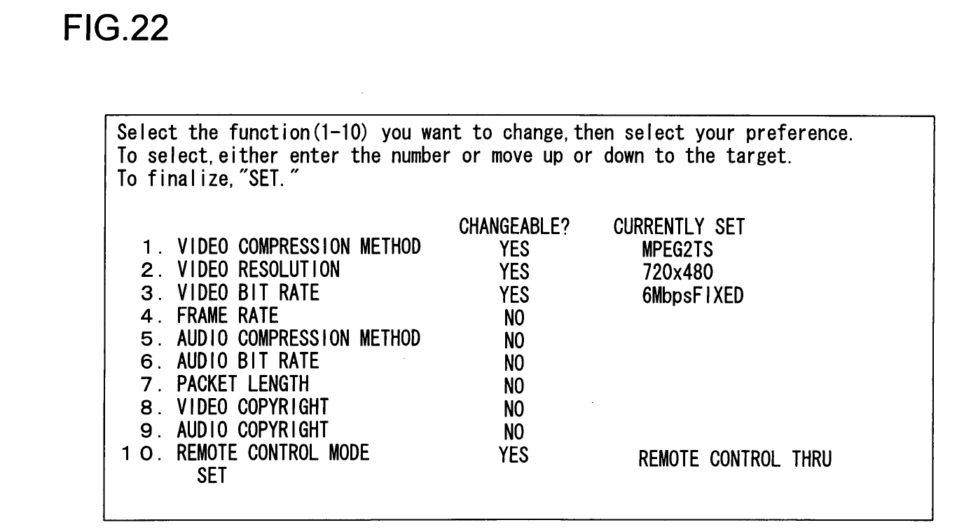

In this embodiment, as opposed to in the first embodiment, to cause the AV data transmission apparatus 1 to perform the initial setting operation for function changing, when a high-frequency signal containing a model ID is transmitted from the AV data reception apparatus 2 to the AV data transmission apparatus 1, the input section 209 is so operated as to enter the functional conditions desired by the user. At this time, on the display section 207, a screen as shown in FIG. 22 is displayed. That is, for a changeable functional condition, the condition entered via the input section 209 is displayed, and an unchangeable functional condition is displayed with an indication “NO” indicating that it cannot be changed.

Then, the model ID determined according to the functional conditions entered via the input section 209 is selected by the specific data memory 206, is then converted into a high-frequency signal, and is then transmitted. When the thus transmitted high-frequency signal containing the model ID is received by the AV data transmission apparatus 1, through the same operations as in the first embodiment, the initial setting operation for function changing is performed. Thus, the AV data transmission apparatus 1 changes the software programs of the video encoding section 111, audio encoding section 113, data generation section 114, and data reception section 118 to those which realize the functions corresponding to the functional conditions selected on the AV data reception apparatus 2.

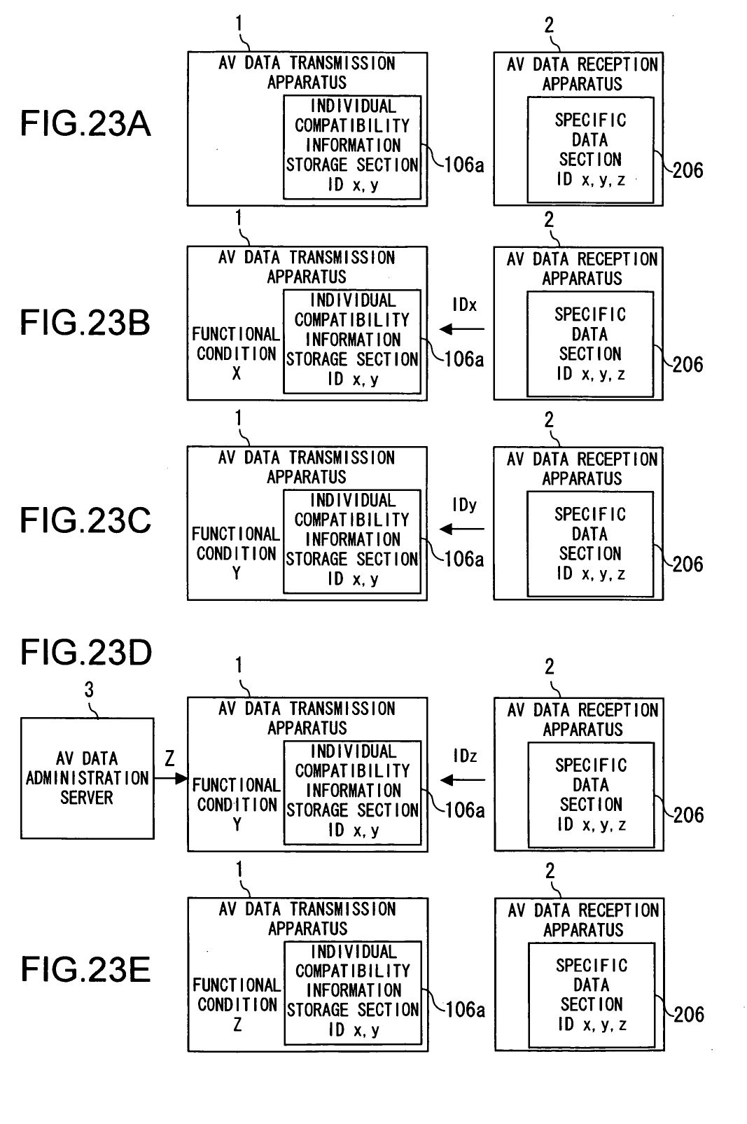

Assume now that, for example, as shown in FIG. 23A, the AV data transmission apparatus 1 is provided with model IDs “x” and “y” and the AV data reception apparatus 2 is provided with model IDs “x” to “z.” When the model ID “x” is transmitted from the AV data reception apparatus 2 to the AV data transmission apparatus 1, then, as shown in FIG. 23B, the initial setting operation is performed to change the functions to those conforming to the functional conditions “X” corresponding the model ID “x,” and communication is performed between the AV data transmission and reception apparatuses 1 and 2. Thereafter, when the model ID “y” is transmitted from the AV data reception apparatus 2 to the AV data transmission apparatus 1, then, as shown in FIG. 23C, the initial setting operation is performed to change the function to those conforming to the functional conditions “Y” corresponding to the model ID “y,” and communication is performed between the AV data transmission apparatus AV data transmission and reception apparatuses 1 and 2.

When the model ID “z” is transmitted from the AV data reception apparatus 2 to the AV data transmission apparatus 1, if the model ID “z” is not stored in the function identification table in the individual compatibility information storage section 106a of the AV data transmission apparatus 1, the AV data transmission apparatus 1 requests from the AV data communication administration server 3 the function data corresponding to the model ID “z” and the software program for performing function changing accordingly. Then, as shown in FIG. 23D, the functional conditions “Z” corresponding to the model ID “z” are transmitted from the AV data communication administration server 3 to the AV data transmission apparatus 1. Thereafter, as shown in FIG. 23E, the AV data transmission apparatus 1 performs the initial setting operation to change the functions to those conforming to the functional conditions “Z” corresponding to the model ID “z,” and the communication is performed between the AV data transmission and reception apparatuses 1 and 2.

In this embodiment, as described above, model IDs as used in the first embodiment are used. It is, however, also possible to realize a system that operates in a similar manner even when apparatus IDs as used in the second embodiment are used instead. In that case, instead of a model identification table and a function identification table as used in the second embodiment, only a function identification table that permits the functional conditions represented by each apparatus ID to be identified may be provided so that, according to the received apparatus ID, the functions of the AV data transmission apparatus 1 are set.

Firth Embodiment

A fifth embodiment of the present invention will be described below with reference to the drawings. In this embodiment, an AV data wireless communication system is configured as shown in FIG. 1, and the AV data transmission apparatus, AV data reception apparatus, and AV data communication administration servers used therein are configured as shown in FIGS. 2 to 4, i.e., as in the first embodiment. Here, the exchange of AV data and control data between the AV data transmission and reception apparatuses is performed in the same manner as in the first to third embodiments, and the initial setting operation for function changing are performed in the same manner as in the first or second embodiments.

In this embodiment, when functional conditions are registered in the function identification table stored in the individual compatibility information storage section 106a of the AV data transmission apparatus 1, all the selectable conditions are registered for the functional conditions of an AV data reception apparatus 2 provided with a functional condition for which a condition can be selected from among a plurality of conditions. Here, for a functional condition for which a plurality of conditions are registered, one among them is registered as the basic condition.

Specifically, for example, assume that the AV data reception apparatus 2 permits choice between the MPEG2_TS and MPEG2_PS methods as the compression method for the video signal and choice among 320×240, 640×480, and 720×480 as the resolution at playback. In this case, in the function identification table of the AV data transmission apparatus 1, under the model ID or apparatus ID corresponding to the AV data reception apparatus 2, the MPEG2_TS and MPEG2_PS methods are registered as the compression method for the video signal and the resolutions 320×240, 640×480, and 720×480 are registered as the resolution at playback. Here, if it is assumed that the MPEG2_TS method and the resolution 640×480 are basic conditions, then, in the function identification table, the MPEG2_TS method is registered as the basic condition of the compression method for the video signal and the resolution 640×480 is registered as the basis condition of the resolution at play back.

Assuming that, in this AV data reception apparatus 2, the other functional conditions are each limited to only one condition, in the function identification table, under the model ID or apparatus ID corresponding to the AV data reception apparatus 2 is registered only one condition for each of those functional conditions. For a functional condition like this that is limited to only one condition, this one condition is dealt with as the basic condition.

In the AV data transmission apparatus 1, during the initial setting operation performed to change its functions to those compatible with the AV data reception apparatus 2, when, ins STEP 6, whether or not the software program for function changing is stored in the recording device section 106 is checked, for an AV data reception apparatus 2 provided with a functional condition for which a condition can be selected from among a plurality of conditions, whether or not the software program corresponding to each of those conditions is recorded is checked. If all the software programs corresponding to those conditions are recorded in the recording device section 106, the flow proceeds to STEP 7, and then the operations starting with STEP 7 are performed to effect function changing in the individual blocks.

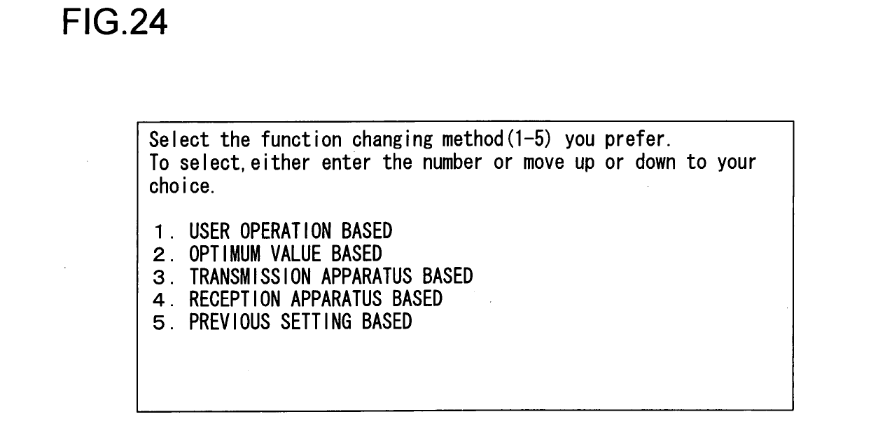

Moreover, in the AV data transmission apparatus 1 is set in advance whether to perform automatically or through setting operation performed by the user the function changing operation that it performs in STEP 7 to set its functions to be compatible with the AV data reception apparatus 2. The operation method set here for the function changing operation is set through the operation of the input section 109 by the user. At this time, the selectable operation methods are displayed on the display section 107 as shown in FIG. 24. The operation method for the function changing operation may be set through an AV data reception apparatus 2 that can communicate with the AV data transmission apparatus 1.

Moreover, as shown in FIG. 24, which shows an example of the display, it is assumed that the operation method for the function changing operation is selectable from among a “user-operation-based setting method”, “optimum-value-based setting method,” “previously-used-setting-based setting method,” “transmitting-apparatus-based setting method,” and “reception-apparatus-based setting method.” If the user-operation-based setting method is selected, at the same time that it is selected, the image quality, sound quality, and power consumption that the user considers to be optimal are also selected. Then, when the function change operation is performed in STEP 7, the functional conditions that realizes a state as close as possible to the selected image quality, sound quality, and power consumption are selected within the range of conditions selectable for the AV data reception apparatus 2 for which function setting is being performed. If the optimum-value-based setting method is selected, when the function changing operation is performed in STEP 7, the functional conditions that achieve the optimum image quality, the optimum sound quality, and the lowest power consummating are selected within the range of conditions selectable for the AV data reception apparatus 2 for which function setting is being performed.

If the previously-used-setting-based setting method is selected, when the function changing operation is performed in STEP 7, the functional conditions that were set when the AV data reception apparatus 2 for which function setting is being performed communicated with the AV data transmission apparatus 1 last time are selected. If the transmitting-apparatus-based setting method is selected, when the function changing operation is performed in STEP 7, in the AV data transmission apparatus 1, functional conditions are displayed on the display section 107, and those of them which are desired by the user are entered through the input section 109 so as t be set. If the reception-apparatus-based setting method is used, fictional conditions are displayed on the display section 207 of the AV data reception apparatus 2, and those of them which are desired by the user are transmitted through the AV data reception apparatus 2 to the AV data transmission apparatus 1 so as to be set.

Furthermore, in the individual compatibility information storage section 106a, there is recorded a previous setting table in which are registered, for each model ID or apparatus ID of the AV data reception apparatus 2, the functional conditions that were set when communication was performed with the AV data reception apparatus 2 provided with that model ID or apparatus ID. For example, assume that, in the function identification table in the individual compatibility information storage section 106a, the MPEG2_TS and MPEG2_PS methods are registered as the compression method for the video signal and the resolutions 320×240, 640×480, and 720×480 are registered as the resolution at playback. Assume also that, when an AV data reception apparatus 2 provided with the model ID or apparatus ID corresponding to those functional conditions communicated with the AV data transmission apparatus 1 last time, the MPEG2_PS method was selected as the compression method for the video signal and the resolution 720×480 was selected as the resolution at playback. In this case, with respect to this model ID or apparatus ID, in the previous setting table are registered the MPEG2_PS method as the compression method for the video signal and the resolution 720×480 as the resolution at playback. In the following description, it is assumed that model IDs are used as in the first embodiment.

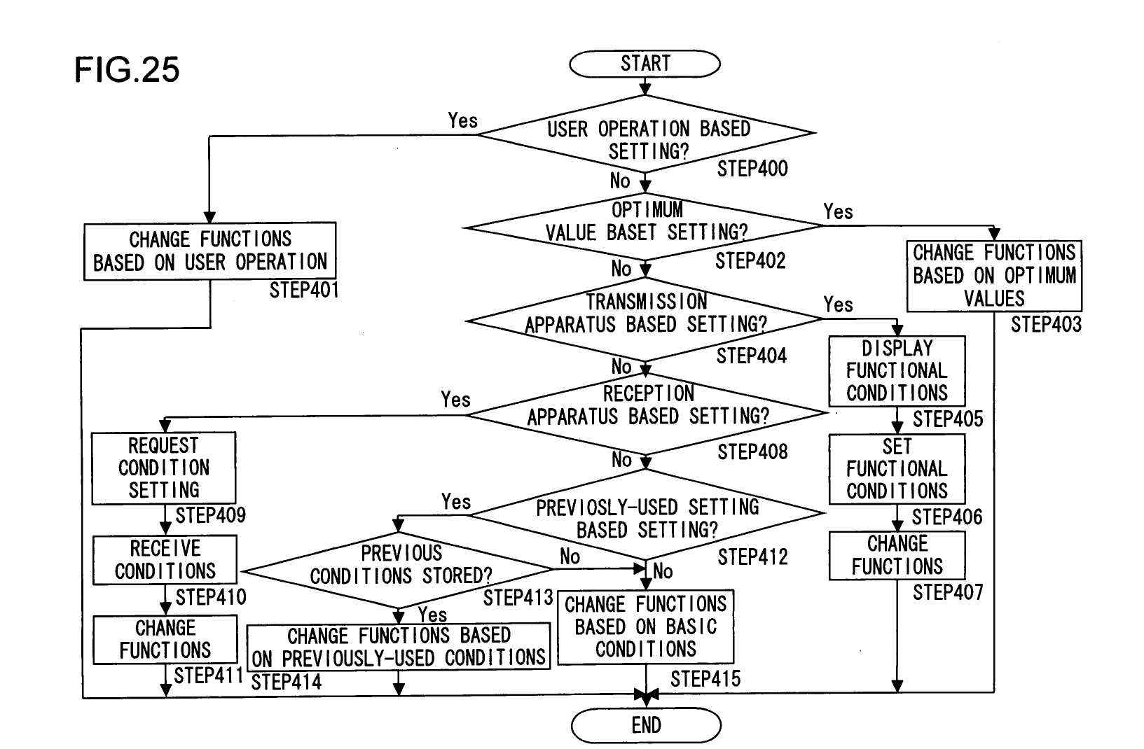

In a case where, as here, there are provided a plurality of operation methods as the operation method for the function changing operation in the AV data transmission apparatus 1, in STEP 7, the previously set operation method is selected according to the flow chart shown in FIG. 25, and the functional conditions that correspond to that operation method are selected to perform the function changing operation. Specifically, first, whether or not the user-operation-based setting method is selected as the operation method for the function changing operation is checked by the system control section 102 (STEP 400).

If it is found that the user-operation-based setting method is selected (Yes), the function changing operation is so performed as to select the functional conditions that archive the image quality, sound quality, and power consumption as close as possible to those set by the user (STEP 401). If the user-operation-based setting method is not selected (No), whether or not the optimum-value-based setting method is selected as the operation method for the function changing operation is checked by the system control section 102 (STEP 402).

If it is found that the optimum-value-based setting method is selected (Yes), the function changing operation is so performed as to select the functional conditions that achieve the optimum image quality, the optimum sound quality, and the lowest power consumption (STEP 403). If the optimum-value-based setting method is not selected (No), whether or not the transmitting-apparatus-based setting method is selected as the operation method for the function changing operation is checked by the system control section 102 (STEP 404).

If it is found that the transmitting-apparatus-based setting method is selected (Yes), the functional conditions corresponding to the recognized model ID are read out from the function identification table in the individual compatibility information storage section 106a, and a screen as shown in FIG. 22 is displayed on the display section 107 (STEP 405). According to this screen on the display section 107, the input section 109 is operated to set the individual functional conditions (STEP 406). Thereafter, according to the functional conditions thus set, the function changing operation is performed (STEP 407).

If, in STEP 404, the transmitting-apparatus-based setting method is not selected (No), whether or not the reception-apparatus-based setting method is selected as the operation method for the function changing operation is checked by the system control section 102 (STEP 408). If it is found that the reception-apparatus-based setting method is selected (Yes), a condition setting request signal for requesting setting of the functional conditions from the AV data reception apparatus 2 having the recognized model ID is fed to the data generation section 114, and is then converted into a high-frequency signal so as to be transmitted via the antenna 122 to the AV data reception apparatus 2 (STEP 409).

In the AV data reception apparatus 2 that receives this condition setting request signal, the functional conditions selectable therein are read out from the BIOS section 203, and a screen as shown in FIG. 22 is displayed on the display section 207. According to this screen on the display section 207, the input section 209 is operated to set the individual functional conditions in the AV data reception apparatus 2. Then, a functional condition notification signal for notifying of the thus set functional conditions is produced by the system control section 202. This functional condition notification signal is fed to the data generation section 216, and is transmitted from the an antenna 210.

When this functional condition notification signal transmitted from the AV data reception apparatus 2 is received via the antenna 122, it is recognized in the data reception section 118, and is then fed through the bus line 123 to the system control section 102 so that the functional conditions recognized from the functional condition notification signal are identified (STEP 410). Then, according to the functional conditions recognized from the functional condition notification signal, the function changing operation is performed (STEP 411). If, in STEP 408, none of the reception apparatus setting methods is selected (No), whether or not the previously-used-setting-based setting method is selected as the operation method for the function changing operation is checked by the system control section 102 (STEP 412).

If it is found that the previously-used-setting-based setting method is selected (Yes), whether or not communication was performed in the past with the AV data reception apparatus 2 having the recognized model ID and thus whether or not the functional conditions used in the communication performed last time are stored in the previous setting table in the AV data transmission apparatus 106a is checked (STEP 413). If the functional conditions used in the communication performed last time are stored in the previous setting table in the AV data transmission apparatus 106a (Yes), the functional conditions corresponding to the recognized model ID are read out from the previous setting table, and, according to these functional conditions, the function changing operation is performed (STEP 414).

If, in STEP 412, the previously-used-setting-based setting method is not selected (No), or if, in STEP 413, no communication has ever been performed with the AV data reception apparatus 2 having the recognized model ID (No), the basic conditions of the individual functional conditions corresponding to the recognized model ID are read out from the function identification table, and, according to these basic conditions of the functional conditions, the function changing operation is performed (STEP 415).

In this embodiment, as described above, model IDs as used in the first embodiment are used. It is, however, also possible to realize a system that operates in a similar manner even when apparatus IDs as used in the second embodiment are used instead.

Sixth Embodiment

A sixth embodiment of the present invention will be described below with reference to the drawings. In this embodiment, an AV data wireless communication system is configured as shown in FIG. 1, and the AV data transmission apparatus, AV data reception apparatus, and AV data communication administration servers used therein are configured as shown in FIGS. 2 to 4, i.e., as in the first embodiment. Here, the exchange of AV data and control data between the AV data transmission and reception apparatuses is performed in the same manner as in the first to third embodiments, and the initial setting operation for function changing are performed in the same manner as in the third embodiment.

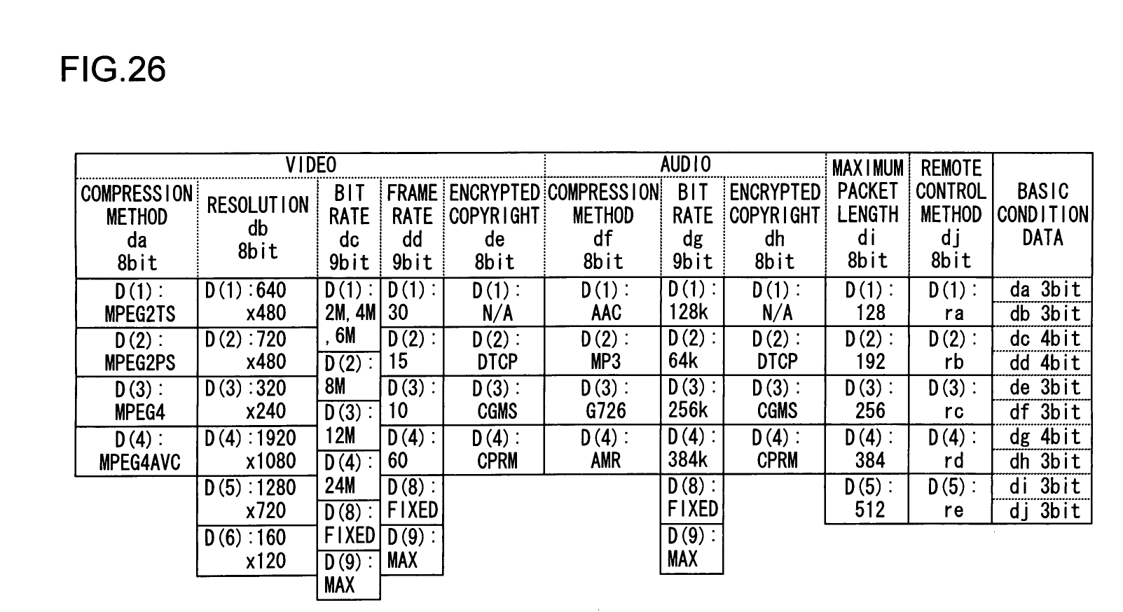

In this embodiment, the function data shown in FIG. 26 of the AV data reception apparatus 2 is dealt with as additional data separate from the apparatus ID, and thus the apparatus ID consists solely of the individual ID. This function data consists of 128 bits composed of 8-bit functional condition data segments “da,” “db,” “de,” “df,” “dh,” “di,” and “dj,” and 9-bit functional condition data segments “dc,” “dd,” and “dg.” The functional condition data segments “da” to “dj” here represent functional conditions similar to those represented by the function data shown in FIG. 15. In the following description, since the apparatus ID consists solely of the individual ID, this apparatus ID will be called the individual ID.

In the function data shown in FIG. 26, in each of the functional condition data segments “da” to “dj,” each bit indicates whether or not a particular functional condition is usable. Suppose that, in each of the functional condition data segments “da” to “dj,” the x-th digit is represented as D(x). For example, in the functional condition data segment that represents the compression method for the video signal, “1” in D(1) indicates that the MPEG2_TS method is usable, “1” in D(2) indicates that the MPEG2_PS method is usable, “1” in D(3) indicates that the MPEG4 method is usable, and “1” in D(4) indicates that the MPEG4_AVC method is usable. Accordingly, for example, when the functional condition data segment “da” is “00000110,” it indicates that the MPEG2_PS method and the MPEG4 method are usable as the compression method for the video signal.

In the functional condition data segments “dc,” “dd,” and “dg” that represent the bit rate of the video signal, the frame rate at playback, the bit rate of the audio signal, and the like, “1” in D(8) indicates a fixed bit (or frame) rate, and “1” in D(9) indicates the maximum bit (or frame) rate. In these functional condition data segments “dc,” “dd,” and “dg,” different combinations of the contents in D(1) to D(7) indicate different bit (or frame) rates usable.

Here, in the function identification tables stored in the AV data transmission apparatus 1 and the AV data communication administration server 3 are registered the functions represented by the respective digits D(x) of the individual functional condition data segments “da” to “dj.” Thus, when the AV data transmission apparatus 1 receives an individual ID and function data from the AV data reception apparatus 2 and checks the digits of the individual functional condition data segments “da” to “dj” contained in that function data, if it is found that the function corresponding to any of them is not registered, the AV data communication administration server 3 is notified of the number of the digit of the relevant functional condition data segment for which the function is not registered in the function identification table. Then, in the AV data communication administration server 3, with reference to the function identification table, the function corresponding to the number of the digit of the relevant functional condition data segment is identified and transmitted to the AV data transmission apparatus 1 so as to be registered in the function identification table in the AV data transmission apparatus 1.

In the other data portion of the function data than the functional condition data segments “da” to “dj,” if there exists any functional condition data segment for which a condition can be selected from among a plurality of conditions, basic condition data is created that represents the basic conditions in the individual functional condition data segments described in connection with the fourth embodiment. This basic condition data contains, for each of the functional condition data segments “da” to “dj,” 3 bits that represent the number of the digit that indicates the condition used as the basic condition. Moreover, in this basic condition data, the functional condition data segments “dc,” “dd,” and “dg” are each allotted one more bit that indicates whether a fixed bit (or frame) rate or the maximum bit (or frame) rate is selected so as to consist of 4 bits in total.

Specifically, for example, when the basic condition for the compression method for the video signal is the MPG4 method, the 3-bit data segment in the basic condition data that is allotted to the compression method of the video signal is “011,” which indicates that the MPEG4 indicated by the third digit is selected as the basis condition. When the basic condition for the bit rate of the video signal is the maximum bit rate and the maximum bit rate is 8 Mbps, the 4-bit data segment in the basic condition data that is allotted to the bit rate of the vide signal is “1010,” consisting of “010,” which indicates that the bit rate 8 Mbps indicated by the second digit is selected as the basis condition, and “1” added thereto to indicate that it is the maximum bit rate.

In this embodiment, as in the fifth embodiment, in the individual compatibility information storage section 106a is stored a previous setting table in which are stored, under each individual ID and thus for each AV data reception apparatus 2, the functional conditions that were used when communication was performed therewith last time. The format of the data registered in this previous setting table may be similar to the one used in the fifth embodiment, or similar to that of the functional condition data described above, or similar to that of the basic condition data described above.

Here, also in this embodiment, as in the fifth embodiment, the operation method of the function changing operation performed in STEP 7 is selectable from among a “user-operation-based setting method”, “optimum-value-based setting method,” “previously-used-setting-based setting method,” “transmitting-apparatus-based setting method,” and “reception-apparatus-based setting method.” One of these operation methods is selected in advance by the user, and is set in the AV data transmission apparatus 1.

When the function changing operation is performed in STEP 7, as in the fifth embodiment, according to the flow chart shown in FIG. 25, the operation method set in advance is selected, and the function changing operation is performed with the functional conditions selected according to that operation method. The operations performed by the thus selected one of the selectable operation methods are the same as in the fifth embodiment, and therefore their detailed explanations will not be repeated. When the reception-apparatus-based setting method is selected, in the functional condition notification signal transmitted from the AV data reception apparatus 2 to the AV data transmission apparatus 1, the data format of the data that represents the set functional conditions may be similar to the one used in the fifth embodiment, or similar to that of the functional condition data described above, or similar to that of the basic condition data described above.

In this embodiment, the function data is separate from the individual ID. It is, however, also possible to deal with the function data and the individual ID together as the apparatus ID.

In all the embodiments described above, if, in the AV data transmission apparatus 1, a code for function data that represents a functional condition corresponding to the AV data reception apparatus 2 for which function changing is to be performed or the software program for realizing that functional condition is not registered or stored, it is automatically requested from the AV data communication administration server 3. It is, however, also possible to permit choice of whether to perform this operation automatically or not.

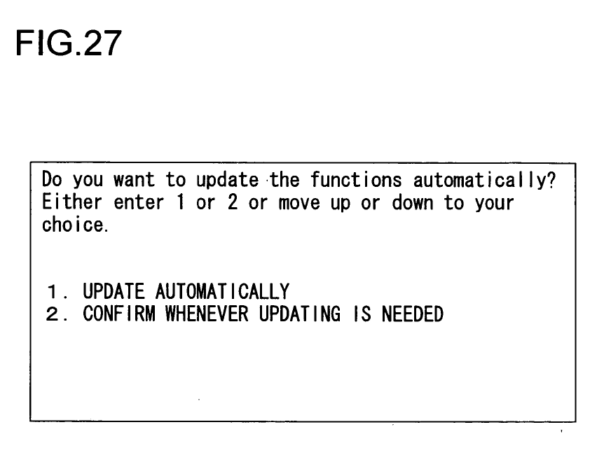

In that case, on the display section 107 of the AV data transmission apparatus 1 or on the display section 207 of the AV data reception apparatus 2, a screen as shown in FIG. 27 is displayed, and the input section 109 of the AV data transmission apparatus 1 or the input section 209 of the AV data reception apparatus 2 is operated to set whether to perform the operation automatically or not. If automatic operation is not selected, when it is found that a code for function data that represents a functional condition or a software program for realizing it is not registered or stored, a screen for asking the user whether to request it or not from the AV data communication administration server 3 is displayed on the display section 107 of the AV data transmission apparatus 1 or on the display section 207 of the AV data reception apparatus 2. Thereafter, whenever the user desires, the input section 109 of the AV data transmission apparatus 1 or the input section 209 of the AV data reception apparatus 2 is so operated as to request the code or the software program from the AV data communication administration server 3.

In the AV data transmission apparatus 1, the individual compatibility information storage section 106a may be provided within the rerecording device section 106, or may be provided within the BIOS section 103. In the AV data reception apparatus 2, the specific data memory 206 may be provided in the BIOS section 203, or, depending on its circuit configuration, may be built with a hard-wired logic that represents the apparatus ID or model ID. All the embodiments deal with an AV data wireless communication system in which AV data is exchanged. However, it is also possible to build data communication systems that handle other data than AV data. It is also possible even to build data communication systems other than wireless communication systems, i.e., wired data communication systems.

In the AV data transmission apparatus 1, when a received apparatus ID or model ID or a received functional condition in function data cannot be identified with reference to the function identification table, the unidentified functional condition is received from the AV data communication administration server 3 and is additionally registered in the function identification table. It is, however, also possible to additionally register not only an unidentified received apparatus ID or model ID or an unidentified received functional condition in function data but all the functional conditions that are not registered in the function identification table of the AV data transmission apparatus 1. Specifically, the AV data communication administration server 3 reads out all the functional conditions that can be set for the AV data transmission apparatus 1 that is requesting additional registration and then transmits them to the AV data transmission apparatus 1 so that, on receiving those functional conditions, the AV data transmission apparatus 1 updates the function identification table.

Likewise, also with respect to the updating of the permitted apparatus table in the AV data transmission apparatus 1, it is possible to make the AV data communication administration server 3 transmit not only the apparatus ID or individual ID for the AV data reception apparatus 2 for which function changing is about to be performed but the apparatus IDs and individual IDs that have not yet been registered in the permitted apparatus table of the AV data transmission apparatus 1 so that these are additionally registered. Likewise, also with respect to the downloading of the software programs for realizing the changed functions, it is possible to make the AV data communication administration server 3 transmit not only the software program for the function that is about to be changed but also the software programs that can be set for the AV data transmission apparatus 1 but have not yet been registered in the AV data transmission apparatus 1 so that these are additionally registered.

These operations performed in the AV data transmission apparatus 1 by using the AV data communication administration server 3 to update the function identification table, the permitted apparatus table, and the software programs for realizing the desired functions may each be performed periodically, instead of being performed every time the initial setting operation is performed for function changing, or may be performed at the request of the user.

According to the present invention, a data transmission apparatus can, by receiving the specific data or function data of a data reception apparatus, identify the data communication functions that suit the data reception apparatus that is requesting data communication and change the functions of the data transmission apparatus itself to those identified data communication functions. Thus, the data transmission apparatus can be made communicable with a data reception apparatus that is not compatible with the currently set data communication functions once the data communication functions with which the data reception apparatus is compatible are identified with reference to its specific data or function data. Moreover, by administering, on a data communication administration server, the data communication functions corresponding to specific data or function data and the software programs for realizing them, it is possible to download and add to the data transmission apparatus such data communication functions and software programs as have hitherto not been identifiable in the data transmission apparatus.

Moreover, according to the present invention, the data transmission apparatus can, based on the specific data of the data reception apparatus, identify the model thereof or the individual data reception apparatus. Thus, the data transmission apparatus can check whether or not it can communicate with the data reception apparatus. Moreover, in a case where the individual data reception apparatus is identified based on the specific data, it is possible to check whether it is a data reception apparatus with which the data transmission apparatus is permitted to comminute. Moreover, by administering, on the data communication administration server, the specific data of data transmission apparatuses on an apparatus-by-apparatus basis, it is possible to administer the data reception apparatuses that can communicate with each data transmission apparatus. Here, in a case where each apparatus has its own specific data, it is possible to administer, on the data communication administration server, the data reception apparatuses that are permitted to communicate with each data transmission apparatus.

1. A data transmission apparatus comprising:
a data generator that generates data transmitted to a data reception apparatus;
a data analyzer that analyzes data received from the data reception apparatus;
a transmitter/receiver that transmits and receives data to and from the data reception apparatus; and
an individual compatibility information storage in which is stored a first function identification table with reference to which data communication functions used to perform data communication with the data reception apparatus are identified respectively for individual items of specific data with which the data reception apparatus permits itself to be identified,
wherein, when the specific data is fed through the data transmitter/receiver to the data analyzer, with reference to the first function identification table in the individual compatibility information storage, the data communication functions recognized from the specific data are identified and are brought into effect so that the data transmission apparatus is brought into a state communicable with the data reception apparatus that has transmitted the specific data thereto.

2. The data transmission apparatus according to claim 1, further comprising:
a communication interface that performs communication with a data communication administration server that administers, for each data transmission apparatus, a second function identification table in which are registered, for each data reception apparatus with which the data transmission apparatus can communicate, the specific data of the data reception apparatus and the data communication functions identified based on the specific data,
wherein, if it is recognized that the specific data received by the data transmitter/receiver is not registered in the first function identification table in the individual compatibility information storage, the data transmission apparatus receives, through the communication interface, contents of the second function identification table stored for the data transmission apparatus itself in the data communication administration server, and updates the first function identification table therewith.

3. The data transmission apparatus according to claim 2,
wherein in the data communication administration server are stored software programs that respectively realize the individual data communication functions, and
wherein, if it is recognized that any of the software programs that realize the data communication functions identified with reference to the first function identification table based on the specific data received by the transmitter/receiver is not present in the data transmission apparatus itself, the data transmission apparatus receives, through the communication interface, the software program from the data communication administration server, and brings into effect the data communication functions identified based on the specific data.

4. The data transmission apparatus according to claim 3,
wherein, when the data transmission apparatus is receiving the contents of the second function identification table or the software program from the data communication administration server, or when the data transmission apparatus is updating the first function identification table or the software program, shutting-down is prohibited.

5. A data transmission apparatus comprising:
a data generator that generates data transmitted to a data reception apparatus;
a data analyzer that analyzes data received from the data reception apparatus;
a transmitter/receiver that transmits and receives data to and from the data reception apparatus; and
an individual compatibility information storage in which is stored a first function identification table in which are recorded data communication functions corresponding respectively to individual codes contained in function data with which the reception apparatus permits data communication functions used for communication therewith to be identified,
wherein, when the function data is fed through the data transmitter/receiver to the data analyzer, with reference to the first function identification table in the individual compatibility information storage, the data communication functions recognized from the codes contained in the function data are identified and are brought into effect so that the data transmission apparatus is brought into a state communicable with the data reception apparatus that has transmitted the function data thereto.

6. The data transmission apparatus according to claim 5, further comprising:
a communication interface that performs communication with a data communication administration server that administers a second function identification table in which are registered the data communication functions assigned to all the codes contained in the function data,
wherein, if it is recognized that any of the codes contained in the function data received by the data transmitter/receiver is not registered in the first function identification table in the individual compatibility information storage, the data transmission apparatus receives, through the communication interface, contents of the second function identification table stored in the data communication administration server, and updates the first function identification table therewith.

7. The data transmission apparatus according to claim 6,
wherein in the data communication administration server are stored software programs that respectively realize the individual data communication functions, and
wherein, if it is recognized that any of the software programs that realize the data communication functions identified with reference to the first function identification table based on the function data received by the transmitter/receiver is not present in the data transmission apparatus itself, the data transmission apparatus receives, through the communication interface, the software program from the data communication administration server, and brings into effect the data communication functions identified based on the function data.

8. The data transmission apparatus according to claim 7,
wherein, when the data transmission apparatus is receiving the contents of the second function identification table or the software program from the data communication administration server, or when the data transmission apparatus is updating the first function identification table or the software program, shutting-down is prohibited.

9. The data transmission apparatus according to claim 5,
wherein the transmitter/receiver receives, for each data reception apparatus, specific data with which the data reception apparatus permits itself to be identified and that differs from one data reception apparatus to another,
wherein in the individual compatibility information storage is further stored a first apparatus table in which are registered the specific data of any data reception apparatus with which the transmission apparatus can communicate, and
wherein, when the specific data is fed through the transmitter/receiver to the data analyzer, with reference to the first apparatus table in the individual compatibility information storage, whether or not the data transmission apparatus can communicate with the data reception apparatus identified based on the specific data is checked.

10. The data transmission apparatus according to claim 9, further comprising:
a communication interface that performs communication with a data communication administration server that administers, for each data transmission apparatus, a second apparatus table in which are registered, for each data reception apparatus with which the data transmission apparatus can communicate, the specific data,
wherein, if it is recognized that the specific data received by the data transmitter/receiver is not registered in the first apparatus table in the individual compatibility information storage, the data transmission apparatus receives, through the communication interface, contents of the second apparatus table stored for the data transmission apparatus itself in the data communication administration server, and updates the first apparatus table therewith.

11. The data transmission apparatus according to claim 10,
wherein, when the data transmission apparatus is receiving the contents of the second apparatus table from the data communication administration server, or when the data transmission apparatus is updating the first apparatus table, shutting-down is prohibited.

12. The data transmission apparatus according to claim 1,
wherein, when function changing is performed for a data reception apparatus provided with a plurality of combinations of data communication functions, the data communication functions that consist of optimum operation conditions are selected.

13. The data transmission apparatus according to claim 1,
wherein, when function changing is performed for a data reception apparatus provided with a plurality of combinations of data communication functions, the data communication functions that consist of operation conditions close to operation conditions selected by a user are selected.

14. The data transmission apparatus according to claim 1, further comprising:
an input section operated by a user,
wherein, when function changing is performed for a data reception apparatus provided with a plurality of combinations of data communication functions, the data communication functions that are entered via the input section are selected.

15. The data transmission apparatus according to claim 1,
wherein in the individual compatibility information storage is stored a previous setting table in which are registered, for each data reception apparatus, the data communication functions that were set when communication was performed therewith last time, and
wherein, when function changing is performed for a data reception apparatus provided with a plurality of combinations of data communication functions, the data communication functions that are registered in the previous setting table with respect to the data reception apparatus are selected.

16. The data transmission apparatus according to claim 1,
wherein, among a plurality of combinations of data communication functions for a single data reception apparatus, one combination is dealt with as basic data communication functions, and
wherein, when function changing is performed for a data reception apparatus provided with a plurality of combinations of data communication functions, the basic data communication functions are selected.

17. The data transmission apparatus according to claim 1,
wherein the data exchanged with the data reception apparatus is copyrighted data, and the data communication functions that are changed include a copyright encrypting method used by the data generator.

18. The data transmission apparatus according to claim 1,
wherein the data exchanged with the data reception apparatus is AV data, and the data communication functions that are changed include at least one of data formats used by the data generator as corresponding to a compression method, a resolution, a bit rate, and a frame rate of a video signal in the AV data.

19. The data transmission apparatus according to claim 1,
wherein the data exchanged with the data reception apparatus is AV data, and the data communication functions that are changed include at least one of data formats used by the data generator as corresponding to a compression method and a bit rate of an audio signal in the AV data.

20. The data transmission apparatus according to claim 1,
wherein the data communication functions that are changed include a data format used by the data generator as corresponding to an optimum packet data length in the data.

21. The data transmission apparatus according to claim 1,
wherein the data communication functions that are changed include a data format used by the data analyzer to analyze the data received from the data reception apparatus in the transmitter/receiver.

22. The data transmission apparatus according to claim 1,
wherein, when the data communication functions are being changed, shutting-down is prohibited.

23. A data reception apparatus comprising:
a data analyzer that analyzes data received from a data transmission apparatus;
a data generator that generates data transmitted to the data transmission apparatus;
a transmitter/receiver that transmits and receives data to and from the data transmitting apparatus; and
a specific data storage in which is stored specific data with which the data reception apparatus permits itself to be identified,
wherein the specific data read out from the specific data storage is transmitted from the transmitter/receiver to the data transmission apparatus so that a data communication function compatible with the data receiving apparatus is identified and brought into effect in the data transmission apparatus so that the data transmission apparatus is brought into a state communicable with the data reception apparatus.

24. The data reception apparatus according to claim 23, further comprising:
an input section operated by a user,
wherein, when a plurality of data communication function are provided, the data communication function that is entered via the input section is transmitted from the transmitter/receiver to the data transmission apparatus so as to notify the data transmission apparatus of the data communication function.

25. A data reception apparatus comprising:
a data analyzer that analyzes data received from a data transmission apparatus;
a data generator that generates data transmitted to the data transmission apparatus;
a transmitter/receiver that transmits and receives data to and from the data transmitting apparatus; and
a specific data storage in which is stored function data composed of codes with which the data reception apparatus permits a data communication function that needs to be used in communication therewith to be identified,
wherein the function data read out from the specific data storage is transmitted from the transmitter/receiver to the data transmission apparatus so that the data communication function compatible with the data receiving apparatus is identified and brought into effect in the data transmission apparatus so that the data transmission apparatus is brought into a state communicable with the data reception apparatus.

26. The data reception apparatus according to claim 25,
wherein in the specific data storage is also stored specific data that permits the data transmission apparatus itself to be identified and that differs from one data reception apparatus to another, and the specific data is transmitted along with the function data from the transmitter/receiver.

27. The data reception apparatus according to claim 26,
wherein in the specific data storage is stored apparatus data composed of the specific data and the function data, and the apparatus data is transmitted from the transmitter/receiver.

28. A data communication system comprising:
the data transmission apparatus according to claim 1; and
the data reception apparatus that performs data communication with the data transmission apparatus,
wherein, when the data transmission apparatus performs data communication with the data reception apparatus, the data communication functions compatible with the data reception apparatus are used.

29. A data communication system comprising:
the data reception apparatus according to claim 23; and
the data transmission apparatus that performs data communication with the data reception apparatus,
wherein, when the data transmission apparatus performs data communication with the data reception apparatus, the data communication functions compatible with the data reception apparatus are used.

30. A data communication system comprising:
the data reception apparatus according to claim 25; and
the data transmission apparatus that performs data communication with the data reception apparatus,
wherein, when the data transmission apparatus performs data communication with the data reception apparatus, the data communication functions compatible with the data reception apparatus are used.

31. A data communication administration server comprising:
a communication interface that exchanges data with the data transmission apparatus according to claim 2; and
a recording device for storing data transmitted from the communication interface to the data transmission apparatus.

32. A data transmission apparatus comprising:
a data generator;
a transmitter/receiver for transmitting data and receiving data from a data reception apparatus;
a data analyzer that analyzes data received from the data reception apparatus; and
an individual compatibility information storage storing a first function identification table including a first plurality of data communication protocols and at least two identifiers associated with at least two of the first plurality of data communication protocols;
wherein, when a first identifier is received by the data analyzer, and the first identifier is one of the at least two identifiers stored in the first function identification table, the data transmission apparatus uses the protocol associated with the first identifier to transmit data.

33. The data transmission apparatus according to claim 32 wherein said at least two identifiers identify a first and a second data reception apparatus.

34. The data transmission apparatus according to claim 32 wherein said at least two identifiers do not uniquely identify a first and a second data reception apparatus.

35. The data transmission apparatus according to claim 32, further comprising:
a communication interface for communicating with a data communication administration server storing a second function identification table including a second plurality of data communication protocols and at least one identifier associated with at least one of the second plurality of data communication protocols;
wherein, if the first identifier received by the data analyzer is not one of the at least two identifiers stored in the first function identification table, the data transmission apparatus receives, through the communication interface, data from the second function identification table to update the first function identification table.

36. A data reception apparatus comprising:
a data generator;
a transmitter/receiver for transmitting data and receiving data from a data transmission apparatus;
a data analyzer that analyzes data received from the data transmission apparatus; and
a specific data storage in which is stored a code indicative of a data communication protocol used by the data reception apparatus, said data storage code being transmitted to the data transmission apparatus by the transmitter/receiver.

37. A data reception apparatus according to claim 36 wherein the code uniquely identifies the data reception apparatus.

38. A method of transmitting data comprising the steps of:
providing a data transmission apparatus;
providing a first function identification table including a first plurality of data communication protocols and at least one identifier associated with at least one of the plurality of data communication protocols;
receiving a first identifier from a data reception apparatus;
if the first identifier is stored in the first function identification table, causing the data transmission apparatus to transmit data using the data communication protocol associated with the first identifier.

39. The method of claim 38 including the additional steps of:
providing a data communication interface;
providing a data communication administration server storing a second function identification table including a second plurality of data communication protocols and at least one identifier associated with at least one of the second plurality of data communication protocols; and
if the first identifier is not stored in the first function identification table, communicating with the data communication administration server and updating the first function identification table with data from the second function identification table.
